(19) United States
(12) Patent Application Publication
(10) Pub. No.: US 2013/0100499 A1
(43) Pub. Date: Apr. 25, 2013

(54) INFORMATION PROCESSING APPARATUS, IMAGE FORMING APPARATUS, AND INFORMATION PROCESSING SYSTEM

(71) Applicant: Oki Data Corporation, Tokyo (JP)

(72) Inventor: Junji KOBAYASHI, Tokyo (JP)

(73) Assignee: OKI DATA CORPORATION, Tokyo (JP)

(21) Appl. No.: 13/660,061

(22) Filed: Oct. 25, 2012

(30) Foreign Application Priority Data
Oct. 25, 2011 (JP) 2011-233980

(51) Int. Cl. G06K 15/02

(52) U.S. Cl. 358/1.15

(57) ABSTRACT

An invented information processing apparatus includes a designating unit for designating a particular letter or string, a judging unit for judging as to whether line data forming text data include the particular letter or string designated by the designating unit, and an editing unit for editing the line data judged by the judging unit as including the particular letter or string. The information processing apparatus can remove redundant data unnecessary for the users with better efficiency.

### BACKGROUND OF THE INVENTION

1. Field of the Invention

This invention relates to an information processing apparatus, an image forming apparatus, and an information processing system for removing data redundant for users.

2. Description of Related Art

Information processing systems formed by connecting information processing apparatuses, such as e.g., personal computers, and servers, and image forming apparatuses, such as, e.g., printers, and multi-function peripherals, and photocopiers, have been widely used in offices or the like in enterprises.

With such an information processing system, for example, an information processing apparatus generates printing job data based on image data to be printed and transmits the printing job data to an image forming apparatus. The image forming apparatus analyses the printing job data upon reception of the printing job data from the information processing apparatus, and retrieves image data and prints the data, or forms images on a printing medium (paper), based on the retrieved image data.

Such information processing systems are expected to save resources such as printing media (paper), developer (toner), electric power, etc. in consideration for environments, these days. In saying about saving the printing medium with the information processing system, the image forming apparatus has a structure that can use printing methods such as double side printing or multipage printing (or namely, a method that image data of plural pages are printed on a single sheet printing medium) based on an instruction from the information processing apparatus (see, e.g., Patent Document #1).
Patent Document #1: Japanese Patent Application Publication No. 2008-221498

Such a conventional information processing system, however, does not have a structure to reduce the data amount of the image data to be printed, and therefore, there raise problems such that printing media are used redundantly and such that images not easily seen by users are printed.

### SUMMARY OF THE INVENTION

This invention is made to solve the above problems, and it is a main object of the invention to provide an information processing apparatus, an image forming apparatus, and an information processing system, for removing data redundant for users.

To solve the above problems, the information processing apparatus according to a first embodiment, includes a designating unit for designating a particular letter or string, a judging unit for judging as to whether line data forming text data include the particular letter or string designated by the designating unit, and an editing unit for editing the line data judged by the judging unit as including the particular letter or string.

In accordance with the invention, the information processing apparatus can remove data redundant for users.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is an illustration showing an entire structure of an information processing system according to a first embodiment;

FIG. 2 is a diagram showing a structure of an information processing apparatus according to the first embodiment;

FIG. 3 is a diagram showing a structure of an image forming apparatus according to the first embodiment;

FIG. 4A is a flowchart showing operation of the information processing system according to the first embodiment;

FIG. 4B is a flowchart showing operation of a modified example of the information processing system according to the first embodiment;

FIG. 5 is a diagram showing a setting example of object key codes used in the first embodiment;

FIG. 6 is a diagram showing a processing example of the information processing system in the first embodiment;

FIG. 7 is a diagram showing a processing example of the information processing system in the first embodiment;

FIG. 8 is a diagram showing a processing example of the information processing system in the first embodiment;

FIG. 9A is a diagram showing a processing example of the information processing system in the first embodiment;

FIG. 9B is a diagram showing a processing example of the information processing system in the first embodiment;

FIG. 10 is a diagram showing a processing example of the information processing system in the first embodiment;

FIG. 11 is a diagram showing a structure of an information processing apparatus according to a second embodiment;

FIG. 12 is a diagram showing a structure of an image forming apparatus according to the second embodiment;

FIG. 13 is a flowchart showing operation of the information processing system according to the second embodiment;

FIG. 14 is a diagram showing a processing example of the information processing system in the second embodiment;

FIG. 15 is a diagram showing a processing example of the information processing system in the second embodiment;

FIG. 16A is a diagram showing a processing example of the information processing system in the second embodiment;

FIG. 16B is a diagram showing a processing example of the information processing system in the second embodiment;

FIG. 17 is a diagram showing a processing example of the information processing system in the second embodiment;

FIG. 18 is a diagram showing a structure of an information processing apparatus according to a third embodiment;

FIG. 19 is a diagram showing a structure of an image forming apparatus according to the third embodiment;

FIG. 20 is a flowchart showing operation of the information processing system according to the third embodiment;

FIG. 21 is a diagram showing a processing example of the information processing system in the third embodiment;

FIG. 22 is a diagram showing a processing example of the information processing system in the third embodiment;

FIG. 23 is a diagram showing a processing example of the information processing system in the third embodiment;

FIG. 24A is a diagram showing a processing example of the information processing system in the third embodiment;

FIG. 24B is a diagram showing a processing example of the information processing system in the third embodiment;

FIG. 25A is a diagram showing a processing example of the information processing system in the third embodiment;

FIG. 25B is a diagram showing a processing example of the information processing system in the third embodiment;

FIG. 26 is a diagram showing an example of a setting screen when object key codes used in the first embodiment are set;

FIG. 27 is a diagram showing an example of a setting screen when object key codes used in the third embodiment are set;

FIG. 28 is a diagram showing an example of a setting screen when object key codes used in the third embodiment are set;

FIG. 29 is a diagram showing an example of a display control unit used in the third embodiment; and

FIG. 30 is a diagram showing an example of a layer structure of a screen used in the third embodiment.

### DETAILED DESCRIPTION OF THE INVENTION

Hereinafter, referring to the drawings, embodiments of the invention (hereinafter, referred to as “these embodiments”) are described in detail. Each drawing are shown schematically to the extent that the invention is adequately understandable. This invention, therefore, is not limited to those shown in the drawings. In those drawings, common structural elements and substantially the same structural elements are given with the same reference numbers, and a duplicated description is omitted.

### First Embodiment

### Structure of Information Processing System

An information processing system 1 according to the first embodiment is a system removing redundant data for users (hereinafter, referred to as “redundant data”) in a case where the image forming apparatus prints image data or where a display device displays image data.

“Redundant data” are data of specific letter or letters (including a pattern data of specific string or strings) judged as an unnecessary portion by a user, and is meaning data to be subject to editing processing (herein, removal processing), or namely “editing subject data.”

It is assumed and described herein that image data to be handled have a structure of image data of emails transmitted and received among plural persons or computers with including a past text, and that blank region data forming redundant data are removed from the past text in the image data.

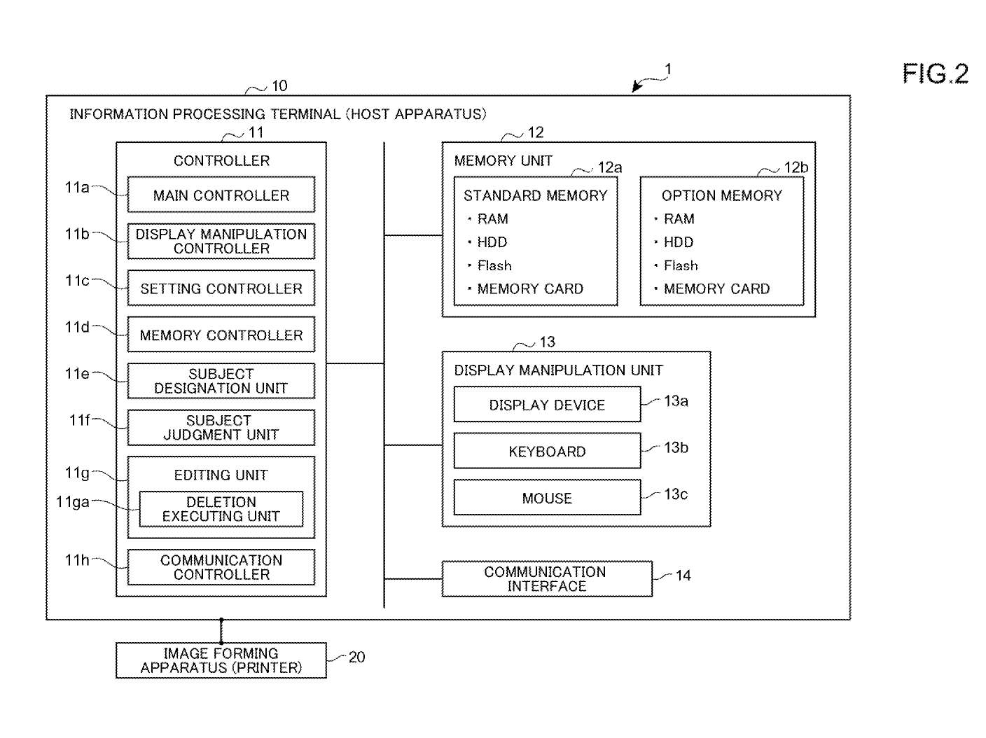

It is also assumed and will be described herein that the information processing system 1 is constructed as a printing system for printing image data at the image forming apparatus. It is to be noted that the information processing system 1 can be formed as a viewing system in which the image data are displayed at a display apparatus (display device 13a (see FIG. 2)) or can be formed as a system serving as printing and viewing systems.

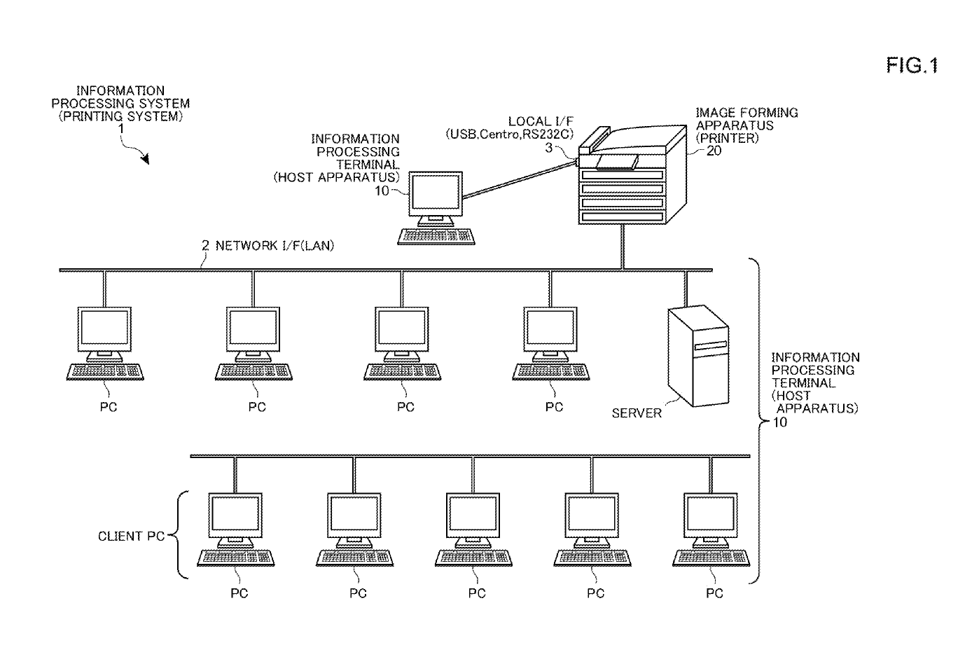

Hereinafter, referring to FIG. 1, the structure of the information processing system 1 according to the first embodiment is described. FIG. 1 is an illustration showing the entire structure of the information processing system according to the first embodiment. As shown in FIG. 1, the information processing system 1 according to the first embodiment includes information processing terminals 10 and image forming apparatuses 20. In this specification, the information processing terminal 10 serves as an information processing apparatus whereas the image forming apparatus 20 also serves as an information processing apparatus. In other words, the information processing apparatus can be an information processing terminal 10 as well as an image forming apparatus 20.

The information processing terminal 10 is a host device of the image forming apparatuses 20, such as, e.g., a personal computer (PC) or server. It is assumed and will be described that the information processing terminal 10 is formed as a personal computer (PC). Operating system (OS), utility software for setting operation of the image forming apparatus 20, and software such as, e.g., printer driver for transmitting printing job data to the image forming apparatus 20, are installed in the information processing terminal 10. The information processing terminal 10 manages the status of the image forming apparatuses 20 based on the manipulation of users, changes settings of the image forming apparatuses 20, and transmits the printing job data to the image forming apparatuses 20.

The image forming apparatus 20 is an apparatus for printing (or namely forming images on a printing medium) based on image data, such as, e.g., a printer, a multifunction printer, and a photocopier. It is assumed and will be described that the image forming apparatus 20 is formed as a printer.

The information processing terminals 10 and the image forming apparatuses 20 are connected in a way communicable via network I/F2 such as LAN or the like, and local connections I/F3, such as USB, Centro, RS232C, etc. In the example shown in FIG. 1, the information processing system 1 has a structure in which the plural information processing terminals 10 are coupled to one image forming apparatus 20 serving as a shared printer via the network I/F2 and local connections I/F3.

### [Structure of Information Processing Terminal]

Hereinafter, a structure of the information processing terminal 10 according to the first embodiment is described in reference to FIG. 2. FIG. 2 is a diagram showing the structure of the information processing terminal according to the first embodiment. As shown in FIG. 2, the information processing terminal 10 includes a controller 10, a memory unit 12, a display manipulation unit 13, and a communication interface 14.

The controller 11 is a function means controlling operation of the information processing terminal 10. The controller 11 is constituted of a CPU (Central Processing Unit). The CPU constituting the controller 11 functions as a main controller 11a, a display manipulation controller 11b, a setting controller 11c, a memory controller 11d, a subject designation unit 11e, a subject judgment unit 11f, an editing unit 11g, and a communication controller 11h, by executing control program pre-stored in a standard memory 12a, as described below, in the memory unit 12.

The main controller 11a is a functioning means for controlling the whole operation of the information processing terminal 10. The display manipulation controller 11b is a functioning means for controlling operation of the display manipulation unit 13. The display manipulation controller 11b renders arbitrary data displayed at the display manipulation unit 13 and receives inputted instructions and data by user's manipulation of the display manipulation unit 13.

The setting controller 11c is a functioning means for registering the setting of the image forming apparatus 20. The setting controller 11c, based on the instructions and data received by the display manipulation controller 11b, registers at a memory unit 22 setting data such as, e.g., selection of the printing manner, or namely single side printing, double side printing, multipage printing, etc., selection of trays containing printing media to be used, and selection of turning on and off of “save mode” function for image data to be printed (or for the image forming apparatus 20). The setting data stored in the memory unit 22 are to be reflected on the printing job data according to the operation.

It is to be noted that “save mode” is an operation mode for saving resources such as, e.g., printing media (paper), developer (toner), and electric power. In the first embodiment, the information processing system 1 performs prescribed editing processing for removing redundant data out of the image data (hereinafter referred to as “removal processing of redundant data”) when the “save mode” is set at a time of image data printing.

The “redundant data” means “editing subject data” subject to the editing processing, or namely removal processing herein, as described above. “Editing subject data (redundant data)” are defined from designating in advance particular letter data (including pattern data of a particular string) to be subject to the removal processing by a user as a key code used when detecting the editing subject data (hereinafter, referred to as “subject key code”). In the first embodiment, data in which the “subject key code” and “blank region data” are composed become the “editing subject data.” The “editing subject data” are removed from the image data by the editing unit 11g because of becoming the redundant data.

The memory controller 11d is a functioning means for controlling and managing the memory unit 12. The memory controller 11d reads out data from the memory unit 12 and memorizes data in the memory unit 12.

The subject designation unit 11e is a functioning means for receiving the particular letter (including a pattern of the particular string) designated by the user. The subject designation unit 11e serves as a designating unit. The “particular letter or string” means a letter or string judged as an unnecessary portion by the user. The subject designation unit 11e registers the data representing the designated particular letter or string (hereinafter referred to as “particular letter data”) to the standard memory 12a or an option memory 12b of the memory unit 12 as the subject key code upon reception of the designation of the particular letter or string.

The particular letter data include pattern data of the particular string, and it is the same in the following description. The particular letter data are used as the subject key code because categorized as a part of the editing subject data. The data in which the “subject key code” and the “blank region data” are composed become the “editing subject data” as described above.

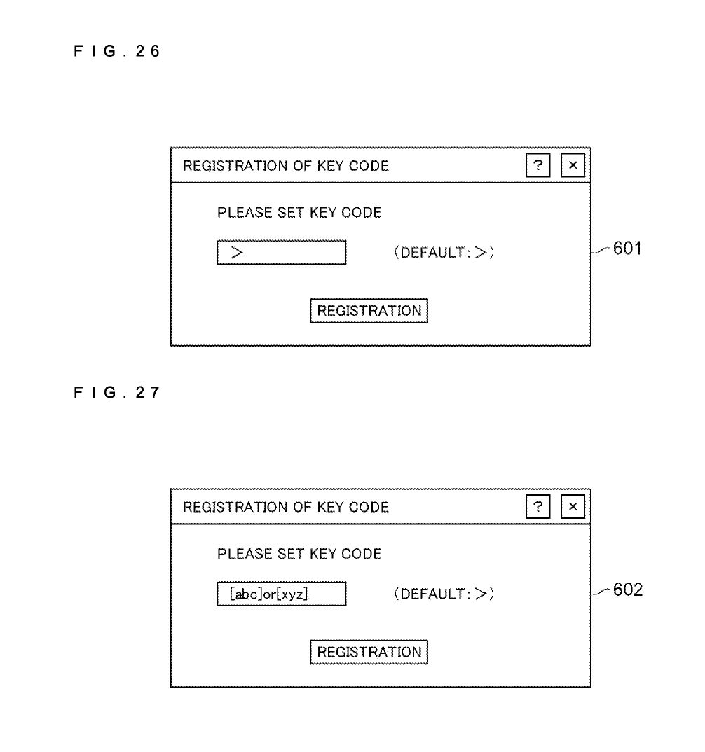

Designation of the particular letter (including the pattern of the particular string) is done by, e.g., user's entry of the particular letter data to be designated as the subject key code at a setting screen 601 (see FIG. 26) of the subject key code of the printer driver displayed on a display device 13a of the display manipulation unit 13. The subject designation unit 11e at that time registers the particular letter data representing the designated particular letter or string to the standard memory 12a or the option memory 12b of the memory unit 12 as the subject key code upon reception of the designation of the particular letter or string as described above. It is to be noted that described in the first embodiment is that the designation of the particular letter (including the pattern of the particular string) can be done only one time.

The subject judgment unit 11f is a functioning means for judging as to whether line data of each line forming the image data (here, image data of text data) contain the editing subject data. The subject judgment unit 11f serves as a judging unit.

In the first embodiment, the subject judgment unit 11f reads out the line data of each line forming the image data from the memory unit 12 line by line, and judges as to whether the subject key codes (or namely, the particular letter data (including the pattern of the particular string) representing particular letter received by the subject designation unit 11e) registered in the memory unit 12 are detected in the read out line data (hereinafter, referred to as “line data under processing”).

The subject judgment unit 11f judges as to whether the editing subject data in which the subject key code and the blank region data are composed are detected in the line data under processing in a case where the subject key code is detected from the line data under processing.

In a case where the editing subject data are detected from the line data under processing, the line data under processing become the line data of the lines subject to removing processing (or deleting processing herein) of the redundant data (hereinafter, referred to as “targeted line”). The “targeted line” is a line containing the editing subject data forming redundant data.

The editing unit 11g is a functioning means for editing image data. “Editing” of the editing unit 11g means operation for removing redundant data from the image data and operation for producing printing job data based on the image data when the image data are printed at the image forming apparatus 20.

The editing unit 11g does removing processing of the redundant data to the line data of the targeted line judged as containing the editing subject data by the subject judgment unit 11f. The editing unit 11g includes a deletion executing unit 11ga as a functioning means for removal.

The deletion executing unit 11ga is a functioning means for deleting the targeted line judged as including the editing subject data by the subject judgment unit 11f on a line basis from the image data.

The communication controller 11h is a functioning means for controlling the operation of the communication interface 14. It is to be noted that the information processing terminal 10 detects the editing subject data from the image data with the subject judgment unit 11f when the image data are printed at the image forming apparatus 20 and deletes the editing subject data from the image data on a line basis as the redundant data with the deletion executing unit 11ga of the editing unit 11g. The editing unit 11g produces the printing job data based on the image data, and the communication controller 11h transmits the printing job data to the image forming apparatus 20.

The memory unit 12 is a memory means for memorizing program and data necessary for operation of the information processing terminal 10. The memory unit 12 is made of, e.g., a non-volatile memory or memories (EEPROM (registered trademark), HDD, Flash (registered trademark), memory card) used as a memory region continuously holding data without affected from turning on and off of the power source, in addition of RAMs used as general work region during operation. In the example shown in FIG. 2, the memory unit 12 is divided into the standard memory 12a and the option memory 12b.

The standard memory 12a is a memory means mounted generally as a memory unit 12. The standard memory 12a stores control programs making the CPU forming the controller 11 function as the main controller 11a, the display manipulation controller 11b, the setting controller 11c, the memory controller 11d, the subject designation unit 11e, the subject judgment unit 11f, the editing unit 11g, and the communication controller 11h.

The display manipulation unit 13 is a structural element displaying a variety of information and receiving user's manipulations. In the example shown in FIG. 2, the display manipulation unit 13 is constituted of the display device 13a, keyboard 13b, and a mouse 13c. The display manipulation unit 13 analyses input signals from the keyboard 13b and the mouse 13 by the user in corresponding to the screen displayed on the display device 13a and outputs inputted instructions and data to the controller 11.

The display device 13a is a display apparatus displaying a variety of information. The display device 13a displays, e.g., settings of the image forming apparatus 20 and image data. The display device 13a is constituted of, e.g., a CRT or LCD. The keyboard 113b is a means for user interface and is an input portion of a key touch type. The mouse 13c is a means for user interface and is an input portion of a button click type.

The communication interface 14 is a structural element for communication with external apparatuses (or image forming apparatuses 20 herein). The communication interface 14 handles data on the entire communication hardware and interfaces including one way and two ways for the information processing terminals 10 as well as the image forming apparatuses 20. As coupling means, plural means such as, e.g., network, Centro, USB, RS232C, wireless LAN, etc. are available.

In the example shown in FIG. 2, the information processing system 1 according to the first embodiment is arranged at the information processing terminal 10 with the subject designation unit 11e, the subject judgment unit 11f, and the editing unit 11g, which are serving as a functioning means for executing removal processing of the redundant data (hereinafter, referred to as “removing means for redundant data”). The removing means for redundant data, however, may be arranged not at the information processing terminal 10 but at the image forming apparatus 20. The information processing terminal 10 outputs the image data after edited at the editing unit 11g to the image forming apparatus 20 serving as the external terminal through the communication interface 14 serving as the output unit.

### [Structure of the Image Forming Apparatus]

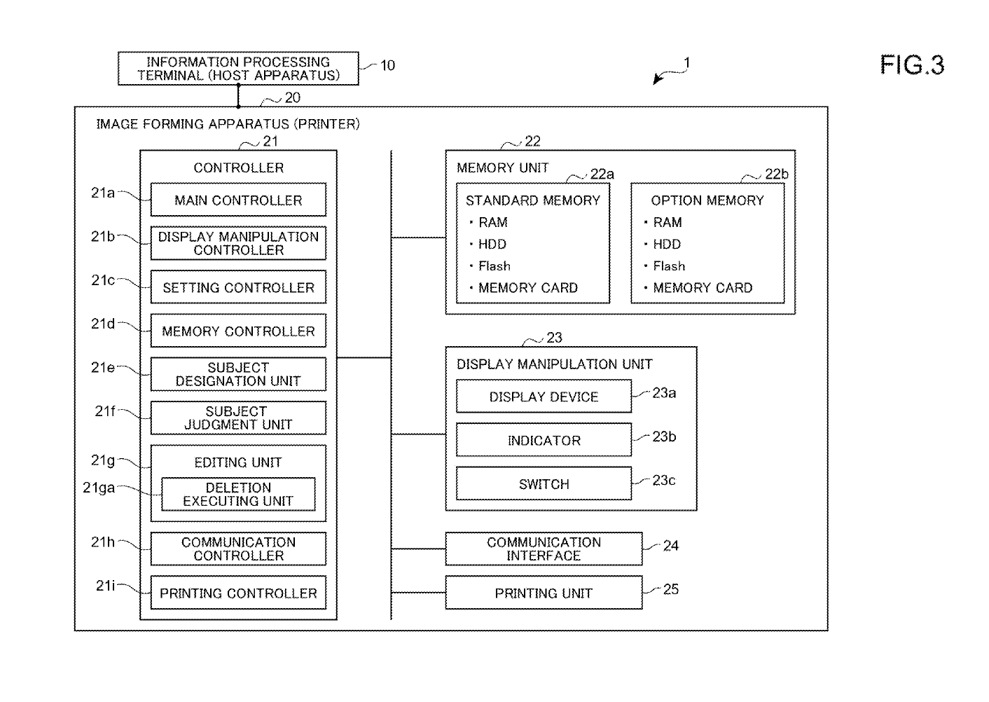

Hereinafter, referring to FIG. 3, the structure of the image forming apparatus 20 according to the first embodiment is described. FIG. 3 is a diagram showing the structure of the image forming apparatus 20 according to the first embodiment. As shown in FIG. 3, the image forming apparatus 20 includes a controller 21, the memory unit 22, and a display manipulation unit 23, a communication interface 24, and a printing unit 25.

The controller 21 is a functioning means for controlling the operation of the image forming apparatus 20. The controller 21 is constituted of a CPU. The CPU constituting the controller 21 functions as a main controller 21a, a display manipulation controller 21b, a setting controller 21c, a memory controller 21d, a subject designation unit 21e, a subject judgment unit 21f, an editing unit 21g, a communication controller 21h, and a printing controller 21i.

The main controller 21a is a functioning means for controlling the whole operation of the image forming apparatus 20. The display manipulation controller 21b is a functioning means for controlling operation of the display manipulation unit 23. The display manipulation controller 21b renders arbitrary data displayed at the display manipulation unit 23 and receives inputted instructions and data by user's manipulation of the display manipulation unit 23.

The setting controller 21c is a functioning means for defining the setting of the image forming apparatus 20. The setting controller 21c, based on the instructions and data received by the display manipulation controller 21b, sets, e.g., selection of turning on and off of the save mode.

The memory controller 21d is a functioning means for controlling and managing the memory unit 22. The memory controller 21d reads out data from the memory unit 22 and memorizes data in the memory unit 22.

The subject designation unit 21e is a functioning means for receiving the particular letter (including a pattern of the particular string) designated by the user. The subject designation unit 21e serves as a designating unit. Designation of the particular letter (including a pattern of the particular string) is done by, e.g., user's entry of the particular letter data (including pattern data of the particular string) to be designated as the subject key code at a setting screen, not shown, of the subject key code displayed on a display device 23a of the display manipulation unit 23. The subject designation unit 21e at that time registers the particular letter data representing the designated particular letter or string to the standard memory 22a or the option memory 22b of the memory unit 22 as the subject key code upon reception of the designation of the particular letter or string as described above.

The subject judgment unit 21f is a functioning means for judging as to whether line data of each line forming the image data (here, image data of text data) contain the editing subject data. The subject judgment unit 21f serves as a judging unit.

In the first embodiment, the subject judgment unit 21f reads out the line data of each line forming the image data from the memory unit 22 line by line, and judges as to whether the subject key codes (or namely, the particular letter data (including the pattern of the particular string) representing particular letter received by the subject designation unit 21e) registered in the memory unit 22 are detected in the read out line data (or namely, “line data under processing”).

The subject judgment unit 21f judges as to whether the editing subject data in which the subject key code and the blank region data are composed are detected in the line data under processing in a case where the subject key code is detected from the line data under processing.

In a case where the editing subject data are detected from the line data under processing, the line data under processing become the line data of the lines subject to removing processing (or deleting processing herein) of the redundant data (or namely, “targeted line”).

The editing unit 21g is a functioning means for editing image data. “Editing” of the editing unit 21g means operation for retrieving image data from printing job data and operation for removing redundant data from the image data.

The editing unit 21g does removing processing of the redundant data to the line data of the targeted line judged as containing the editing subject data by the subject judgment unit 21f. The editing unit 21g includes a deletion executing unit 21ga as a functioning means for removal.

The deletion executing unit 21ga is a functioning means for deleting the targeted line judged as including the editing subject data by the subject judgment unit 21f on a line basis from the image data.

The communication controller 21h is a functioning means for controlling the operation of the communication interface 24. The printing controller 21i is a functioning means for controlling the printing unit 25. The printing controller 21i outputs to the main controller 25a a variety of information such as, e.g., data of end of printing, printing error, and shortage of developing agent in accordance with the status of the printing unit 25. The main controller 21a manages the operation of the printing unit 25 according to the contents of the data outputted from the printing controller 21i.

It is to be noted that the image forming apparatus 20 renders the communication controller 21h receive printing job data from the information processing terminal 10 and renders the editing unit 21g analyze the printing job data to retrieve the image data when an image in the image data contained in the printing job data received from the information processing terminal 10 is to be printed. The subject judgment unit 21f detects the editing subject data from the image data, and the deletion executing unit 21ga of the editing unit 21g deletes the editing subject data from the image data on a line basis as the redundant data portion. The printing controller 21i then drives the printing unit 25 based on the image data to print images at the printing unit 25, or namely forming images on a printing medium.

The memory unit 22 is a memory means for memorizing programs and data necessary for operation of the image forming apparatus 20. The memory unit 22 is made of, e.g., a non-volatile memory or memories (EEPROM, HDD, Flash, memory card) used as a memory region continuously holding data without affected from turning on and off of the power source, in addition of RAMs used as general work region during operation. In the example shown in FIG. 3, the memory unit 22 is divided into a standard memory 22a and the option memory 22b.

The standard memory 22a is a memory means mounted generally as the memory unit 22. The standard memory 22a stores control programs making the CPU forming the controller 21 function as the main controller 21a, the display manipulation controller 21b, the setting controller 21c, the memory controller 21d, the subject designation unit 21e, the subject judgment unit 21f, the editing unit 21g, the communication controller 21h, and the printing controller 21i. The option memory 22b is a memory means optionally mounted as the memory unit 22.

The display manipulation unit 23 is a structural element displaying a variety of information and receiving user's manipulations. In the example shown in FIG. 3, the display manipulation unit 23 is constituted of a display device 23a, an indicator 23b, and a switch 23c. The display manipulation unit 23 analyzes input signals from the switch 23c by the user in corresponding to the screen displayed on the display device 23a and outputs inputted instructions and data to the controller 21.

The display device 23a is a structural element displaying a variety of information. The display device 23a displays, e.g., settings of the image forming apparatus 20 and image data. The display device 23a is constituted of, e.g., an LCD. The indicator 23b is a structural element displaying data such as, e.g., the status of the image forming apparatus 20 with emitting light. The indicator 23b is made of, e.g., plural LED elements. The indicator 23b transmits a variety of information to users by turning on and off or tinkering the plural LED elements or by changing the tinkering period or changing the combination of turning on and off. The switch 23c is a one means of user interface and may be formed of an input portion of a button type or a touch panel type.

The communication interface 24 is a structural element for communication with external apparatuses (or information processing terminals 10 herein). The communication interface 24 handles data on the entire communication hardware and interfaces including one way and two ways for the information processing terminals 10 as well as the image forming apparatuses 20. As coupling means, plural means such as, e.g., network, Centro, USB, RS232C, wireless LAN, etc. are available. The printing unit 25 is a structural element for forming images on a printing medium. The printing unit 25 delivers the printing medium to the exterior.

With the structure thus formed, the information processing system 1 performs removing processing of the redundant data (herein, deleting processing) to the image data at either of the information processing terminal 10 and the image forming apparatus 20 when the image of the image data is printed.

It is to be noted that the removing means of the redundant data of the information processing terminal 10 (or namely, the subject designation unit 11e, the subject judgment unit 11f, and the editing unit 11g) and the removing means of the redundant data of the image forming apparatus 20 (or namely, the subject designation unit 21e, the subject judgment unit 21f, and the editing unit 21g) serve for the same function. Accordingly, the removing processing of the redundant data can be done at either of the information processing terminal 10 and the image forming apparatus 20.

The removing means of the redundant data can share the processing role between the information processing terminal and the image forming apparatus or among those and a functioning means not shown, if the same function can be realized. Accordingly the structure of the information processing system 1 is not limited to the structure shown in FIG. 2 and FIG. 3.

### [Operation of the Information Processing System]

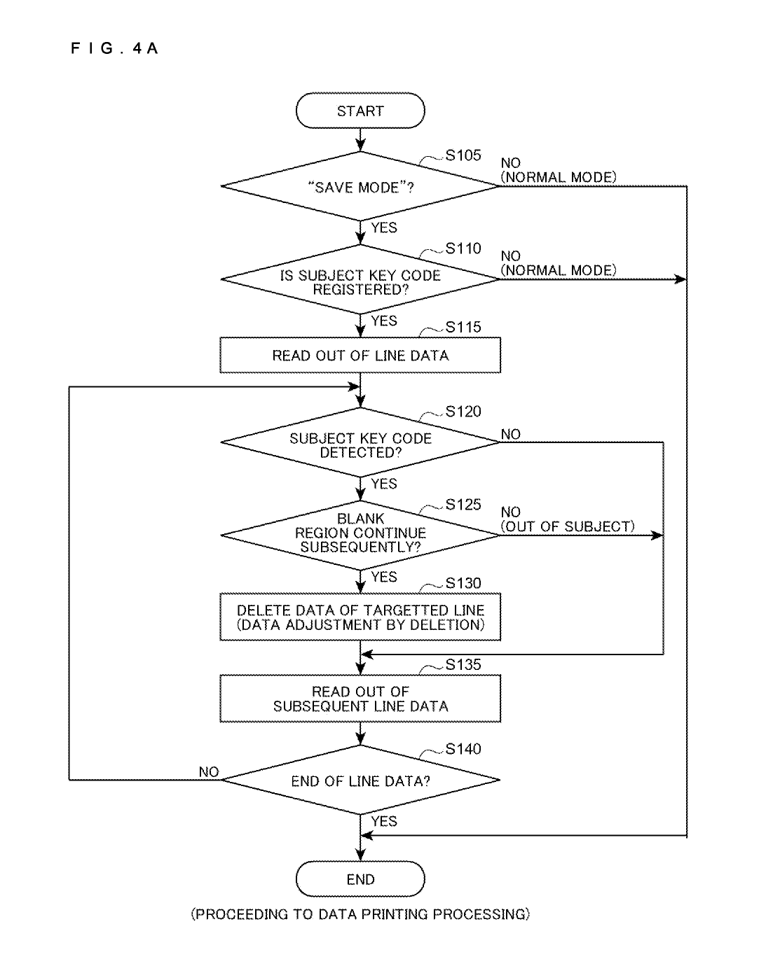

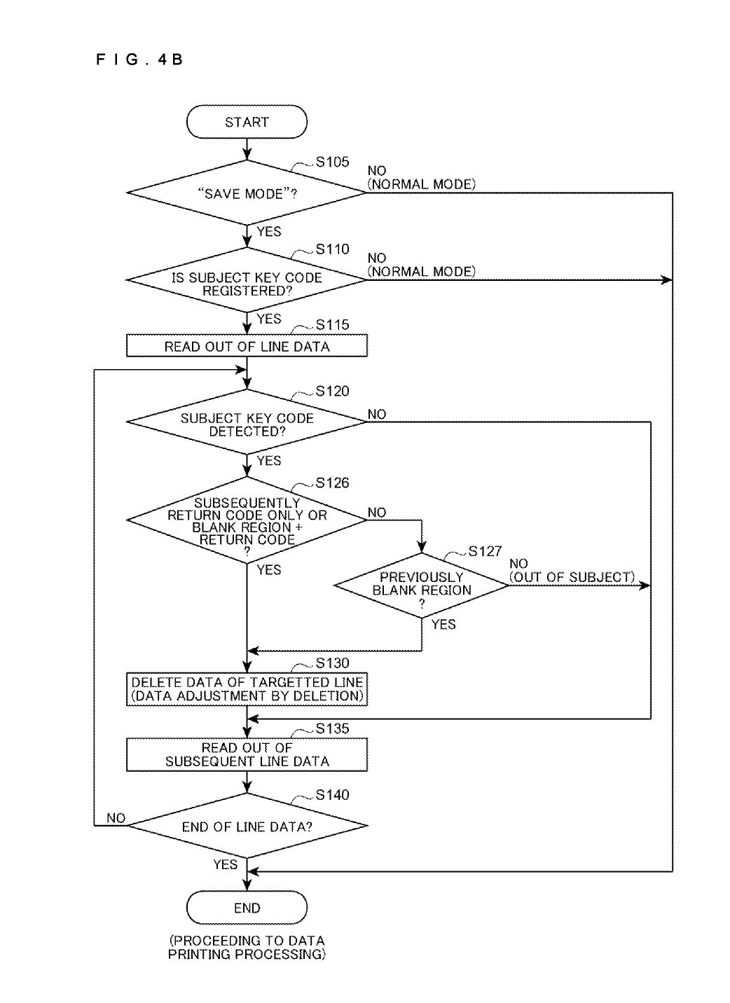

The operation of the information processing system 1 is characterized in that the removing processing of redundant data is made to the image data. Hereinafter, referring to FIG. 4A, the operation of the information processing system 1 according to the first embodiment at a time of the removing processing of redundant data is described. FIG. 4A is a flowchart showing operation of the information processing system according to the first embodiment.

The operation of each apparatus is determined by the programs stored in advance in a way retrievable to the memory unit in the each apparatus, and is executed with the controller in each apparatus. Communications between apparatuses are done by temporarily storing, to a memory unit, data received by the apparatus on a receiver side through communications and by reading the data out of the memory unit. The data are temporarily stored in the memory unit and subsequently outputted to a prescribed structural element for performing the subsequent processing. Those operations are omitted from a detailed description because no more than ordinary means in the field of data processing.

FIG. 4A shows operation of either of the information processing terminal 10 or the image forming apparatus 20 constituting the information processing system 1 in a case where performing the removing processing of redundant data to the image data.

Herein, operation is described in a case where the image forming apparatus 20 performs removing processing of redundant data to image data contained in a printing job data where receiving the printing job data from the information processing terminal 10.

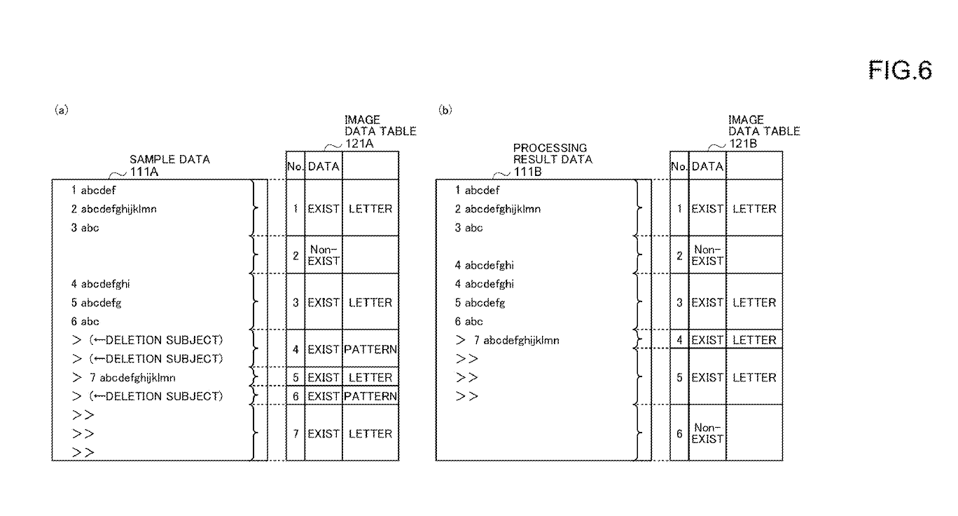

It is assumed and described that redundant data are removed from image data of emails transmitted and received among plural persons as shown in, e.g., FIG. 6 to illustrate easily the operation at the time of removing processing of redundant data in the information processing system 1.

The image data of the email are structured with additions of a sign such as “>”, which is added to a past text portion where the image data are structured to contain the past text. The past text portion of the image data may include plural lines (hereinafter, referred to as “blank lines”) made of an useless blank region (a region of return codes only, or a region of a structure in combination of either or both of space key and tab key and return codes). In this situation, the line data of the blank lines become the redundant data. The information processing system 1 removes the line data of the blank lines as the redundant data from the image data.

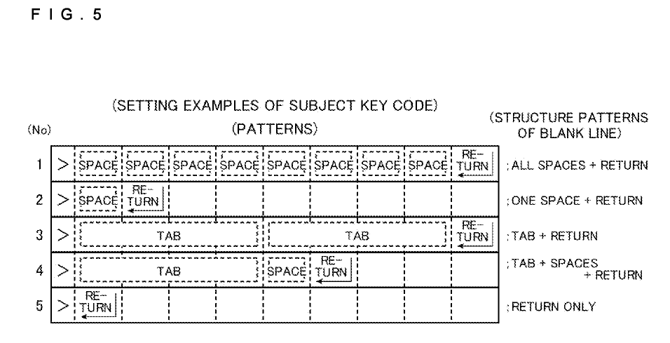

The structure of the blank lanes is made of a structure as shown in, e.g., FIG. 5. FIG. 5 is a diagram showing a setting example of the subject key code used in the first embodiment. In the example shown in FIG. 5, letter “>” is set as the subject key code, and the data in combination of the subject key code and the “blank region data” become the editing subject data (or namely, data subjecting the removing processing of the redundant data).

As shown in FIG. 5, the blank lines have a structure in which the subject key code and the blank region data are combined. The blank lines have the structure that the region below the subject key code “<” is made of any of the following five type structural patterns. A first structural pattern is made of plural space codes and a return code; a second structural pattern is made of a single space code and a return code; a third structural pattern is made of a single or plural tub codes and a return code; a fourth structural pattern is made of a combination of a single or plural tab codes and a single or plural space codes, and a return code; and a fifth structural pattern is made of a return code only.

In a case where a user designates the letter “>” as the subject key code, the information processing system 1 views the data satisfying any one of the first to fifth embodiments as the editing subject data and deletes the editing subject data as the redundant data from the image data on the line basis. The information processing system 1 thereby performs the removing processing of the redundant data (herein, deleting processing).

More specifically, with the first embodiment, in the information processing system 1, where the user designates the letter “>” as the subject key code, the subject judgment unit 11f or 21f reads the line data of each line forming the image data out of the memory unit 12 or 22, and judges as to whether the subject key code “>” is detected from the read-out line data (or namely, the line data under processing).

The subject judgment unit 11f or 21f judges as whether the editing subject data combining the subject key code “>” and the blank region data are detected in the line data under processing in a case where the subject key code is detected from the line data under processing.

Where the line data under processing contain data satisfying any one of the first to fifth structural patterns, the subject judgment unit 11f or 21f detects the data as the editing subject data.

Then, in the information processing system 1, the deletion executing unit 11ga of the editing unit 11g or the deletion executing unit 21ga of the editing unit 21g renders the editing subject data as the redundant data, renders the lines containing the editing subject data as the targeted lines, and deletes the targeted lines from the image data on the line basis. Thus, the information processing system 1 performs the removing processing of the redundant data (or deleting processing herein).

The removing processing of the redundant data can be done in a situation other than the situation above. For example, in the information processing system 1, the information processing terminal 10 performs the removing processing of the redundant data to the image data, and the printing job data is produced based on the image data made after removing processing of redundant data to transmit the printing job data to the image forming apparatus 20. In this situation, the image forming apparatus 20 prints the image of the image data contained in the received printing job data as it is.

In this case, the removing processing of the redundant data is performed in substantially the same way as by the removing means of the redundant data (the subject designation unit 11e, the subject judgment unit 11f, and the editing unit 11g) of the information processing terminal 10 in lieu of the removing means of the redundant data (the subject designation unit 21e, the subject judgment unit 21f, and the editing unit 21g) of the image forming apparatus 20. A detailed description for that is omitted herein. In this embodiment, the information processing system 1 may not delete the lines in a case where useful information or data are located above or below the particular letter or string by judging as to whether any blank data is contained below or above the particular letter or string in the line containing the particular letter or string. However, the editing unit 11g may delete the line data subsequent to the particular letter designated with the subject designation unit 11e, where simply intending saving of paper.

In the information processing system 1, the image data after the removing processing of the redundant data can be displayed on the display apparatus (herein, the display device 13a). In this situation, the information processing system 1 renders the information processing terminal 10 perform the removing processing of the redundant data to the image data and display the image data after the removing processing of the redundant data on the display apparatus (the display device 13a).

In this case, the removing processing of the redundant data is performed in substantially the same way as by the removing means of the redundant data (the subject designation unit 11e, the subject judgment unit 11f, and the editing unit 11g) of the information processing terminal 10 in lieu of the removing means of the redundant data (the subject designation unit 21e, the subject judgment unit 21f, and the editing unit 21g) of the image forming apparatus 20. A detailed description for that is omitted herein.

It is assumed that the user designates in advance the selection of turning on and off of “save mode” function by manipulating the display manipulation unit 13 of the information processing terminal 10 to the image data to be printed (or namely, the image forming apparatus 20). Therefore, setting data for designating the selection of turning on and off of “save mode” function is contained in the printing job data transmitted to the image forming apparatus 20 from the information processing terminal 10.

In addition, where the user designates the subject key code (the particular letter data (including pattern data of the particular string) subjecting the removing processing of the redundant data) by manipulating the display manipulation unit 13 of the information processing terminal 10, the information processing terminal 10 notifies the image forming apparatus 20 of the subject key code.

For example, in the information processing system 1, where the user designates the subject key code (the particular letter data (including pattern data of the particular string) subjecting to the removing processing of the redundant data) on the setting screen 601 (see FIG. 26) of the subject key code of the printer driver by manipulating the display manipulation unit 13 of the information processing terminal 10, the subject designation unit 11e of the information processing terminal 10 temporarily registers the subject key code in the memory unit 12. FIG. 26 is a diagram showing an example of a setting screen at a time that the subject key code is set. In the example shown in FIG. 26, the letter “>” is entered in an entry field as a candidate of the subject key code, and the letter “>” is designated as the subject key code upon the user's pushing down of the “registration” button. The subject designation unit 11e of the information processing terminal 10 temporarily registers the designated subject key code in the memory unit 12.

In the information processing system 1, the main controller 11a of the information processing terminal 10 reads out the subject key code from the memory unit 12 during printing or even before printing and transmits the code to the image forming apparatus 20. The transmission of the subject key code from the information processing terminal 10 to the image forming apparatus 20 may be done by rendering the subject key code contained in the printing job data. The subject designation unit 21e of the image forming apparatus 20 makes registration of the subject key code in the memory unit 22 in response to this operation.

Where the user registers the subject key code (the particular letter data (including pattern data of the particular string) subjecting the removing processing of the redundant data) by manipulating the display manipulation unit 23 of the image forming apparatus 20, the subject designation unit 21e of the image forming apparatus 20 registers the subject key code in the memory unit 22.

Hereinafter, as described above, the operation at a time for removing processing of the redundant data to the image data contained in the printing job data where the image forming apparatus 20 receives the printing job data from the information processing terminal 10, is described.

At the image forming apparatus 20, if the communication controller 21h receives the printing job data from the image forming apparatus 10, the printing job data are stored temporarily in the memory unit 22. The editing unit 21g reads out the printing job data from the memory unit 22, analyses the printing job data, retrieves image data, and temporarily stores the retrieved image data in the memory unit 22. The image forming apparatus 20, with this operation, begins processing of a series of routines shown in FIG. 4A as a removing processing of the redundant data.

As shown in FIG. 4A, in the image forming apparatus 20, the main controller 21a judges as to whether the “save mode” function is set to the image data (or the image forming apparatus 20) (S105).

The main controller 21a judges that the “save mode” function is set where the printing job data contains the setting data designating turning on of the “save mode” function, whereas judging that the “save mode” function is not set where the printing job data does not contain the setting data designating turning on of the “save mode” function or where the printing job data contains the setting data designating turning off of the “save mode” function.

In a case where it is judged as that the “save mode” function is set (in a case of “Yes”) at the judgment at S105, the processing proceeds to S110. One the other hand, in a case where it is judged as that the “save mode” function is not set (in a case of “No”), the processing ends. In this situation, the image forming apparatus 20 prints images in the normal mode, which for not doing any saving.

In a case where it is judged as that the “save mode” function is set (in a case of “Yes”) at the judgment at S105, the subject judgment unit 21f judges as to whether any subject key code (any particular letter data (including pattern data of a particular string) subjecting to the removing processing of the redundant data) is registered (S110).

In a case where it is judged as that the subject key code is registered in the memory unit 22 at the judgment of S110 (in a case of “Yes”), the processing proceeds to S115. On the other hand, in a case where it is judged as that the subject key code is not registered in the memory unit 22 at the judgment of S110 (in a case of “No”), the processing ends. In this situation, the image forming apparatus 20 prints images in the normal mode, which for not doing any saving.

In a case where it is judged as that the subject key code is registered in the memory unit 22 at the judgment of S110 (in a case of “Yes”), the subject judgment unit 21f judges as to whether the line data of each line forming the image data (the image data of the text data) contain the editing subject data.

For example, in a case where it is judged that the subject key code is registered in the memory unit 22 at the judgment of S110 (in a case of “Yes”), the subject judgment unit 21f reads out the line data of the first line of the image data from the memory unit 22 (S115).

Next, the subject judgment unit 21f judges as to whether the subject key code is detected in the read out line data, or namely the line data under processing (S120). In a case where the subject key code is detected at the judgment of S110 (in a case of “Yes”), the processing proceeds to S125 because the line data under processing are the line data possibly containing the editing subject data. On the other hand, where it is judged that no editing subject data is detected at the judgment at S120 (in a case of “No”), the processing proceeds to S135 because the line data under processing are the line data, as not to be subjected, impossibly containing the editing subject data.

In a case where it is judged that the subject key code is detected at the judgment of S120 (in a case of “Yes”), the subject judgment unit 21f judges as to whether the blank regions continue after the subject key code in the line data under processing (S125).

The patterns in combination of the subject key code and the blank region fall into any of one of the first to the fifth structural patterns. The first to the fifth structural patterns are defined by the control program stored in the memory unit 22 in advance. The subject judgment unit 21f performs detecting processing of data matching to any pattern of the first to the fifth structural patterns from the line data under processing based on the control program.

In a case where it is judged that the blank regions continue after the subject key code at the judgment of S125 (in a case of “Yes”), the processing proceeds to S130 because the line data under processing are the line data possibly containing the editing subject data. On the other hand, in a case where it is judged that the blank regions do not continue after the subject key code at the judgment of S125 (in a case of “No”), the processing proceeds to S135 because the line data under processing are the line data, as not to be subjected, impossibly containing the editing subject data.

In a case where it is judged that the blank regions continue after the subject key code at the judgment of S125 (in a case of “Yes”), the deletion executing unit 21ga of the editing unit 21g deletes the line data under processing from the image data on the line basis because the line data under processing are the line data of the targeted line including the editing subject data (S130). The image forming apparatus 20 performs the deleting processing of the editing subject data as the redundant data and consequently can adjust the image data so that the image data can be seen easily.

In a case where it is judged that no editing subject data is detected at the judgment at S120 (in a case of “No”) or that the blank regions do not continue after the subject key code at the judgment of S125 (in a case of “No”), or after the step of S130, the subject judgment unit 21f reads out the subsequent line data of the image data from the memory unit 22.

The subject judgment unit 21f judges as to whether finishing the line data or whether reading out of the line data of the last line is ended (S140). In a case where it is judged that the processing finishes the line data or namely reading out of the line data of the last line is finished (in a case of “Yes”), the processing ends. On the other hand, where it is judged that the processing does not yet finish the line data or namely reading out of the line data of the last line is not yet finished (in a case of “No”), the processing returns to S120. Consequently, in this case, the image forming apparatus 20 repeats the processing between S120 and S140.

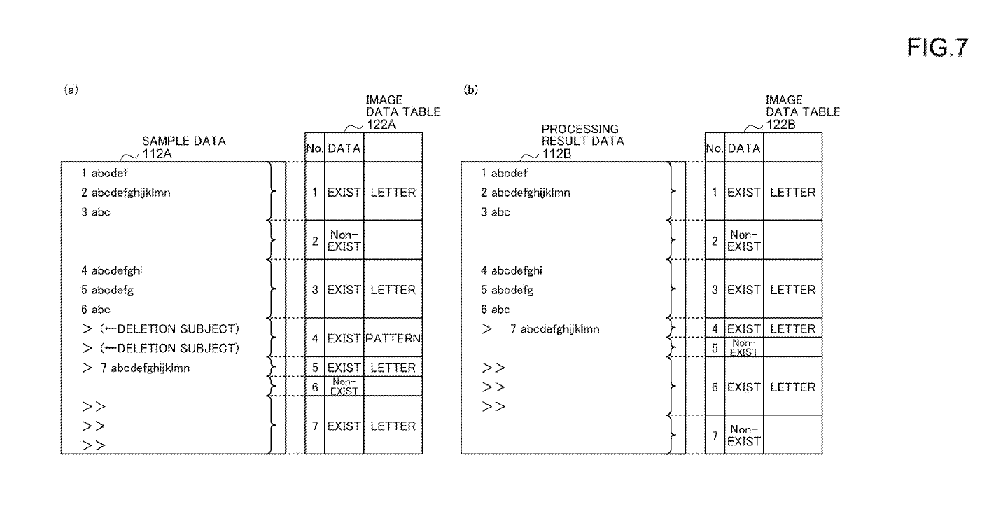

The information processing system 1 thus performs the removing processing of the redundant data to the image data. The information processing system 1 with this operation can do processing shown in FIG. 6 and FIG. 7 as an example.

FIG. 6 is a diagram showing a processing example of the information processing system according to the first embodiment. FIG. 6(a) shows printing sample data 111A before the removing processing of the redundant data (hereinafter referred to as “preprocessing”) and an image data table 121A showing its structural contents. FIG. 6(b) shows printing sample data 111B after the removing processing of the redundant data (hereinafter referred to as “post-processing”) to the preprocessing printing sample data (herein, the printing sample data 111A) and an image data table 121B showing its structural contents.

It is to be noted that the term “image data table” indicates whether data exist on each line of the corresponding image data (herein, the printing sample data or processing result data), and the data are what kind of data (e.g., letters or patterns) where the data exist.

In the example shown in FIG. 6, the post-processing processing result data 111B have the data of data of two lines of “No. 4” and one line data of “No. 6” of the image data table 121A shown in FIG. 6 deleted in comparison with the pre-processing printing sample data 111A.

FIG. 7 is a diagram showing a processing example of the information processing system according to the first embodiment. FIG. 7(a) shows preprocessing printing sample data 112A and an image data table 122A showing its structural contents. FIG. 7(b) shows post-processing printing sample data 112B and an image data table 122B showing its structural contents.

In the example shown in FIG. 7, the post-processing processing result data 112B have the data of two lines of “No. 4” of the image data table 122A shown in FIG. 7(a) deleted in comparison with the pre-processing printing sample data 112A.

The information processing system 1 thus can reduce the data amount of the image data to be printed by performing the removing processing of the redundant data to the image data in accordance with the flow shown in FIG. 4A. The information processing system 1 therefore can save the resources of printing medium (paper) to be used more than conventional information processing systems. The information processing system 1 can also save the resources of not only the printing medium but also such as developer (toner) and electric power, etc.

The printed images are made to be easily viewed because the redundant data are removed already. The information processing system 1 can therefore print images easily viewed by the users.

### [Modifications of Operation of the Information Processing System]

The information processing system 1 can improve efficiency of the removing processing of the redundant data by rendering not only the region below the subject key code “>” but also the region above the subject key code “>” being subject of the detection of the editing subject data. For example, the targeted line in which a blank region exists not only below the subject key code “>” but also above the subject key code “>” is highly presumed as an useless blank line. Here, an example is shown in which a part of operation is modified to render the information processing system 1 capable of removing such a targeted line chiefly from the image data.

Hereinafter, referring to FIG. 4B, a modified example of operation of the information processing system 1 according to the first embodiment is described. FIG. 4B is a flowchart showing a modified example of operation of the information processing system 1 according to the first embodiment.

The flow of the modified example shown in FIG. 4B is different, in comparison with the flow shown in FIG. 4A, in a point of performing the processing of S126 and the processing of S127, in lieu of the processing of S125 shown in FIG. 4A (judgment processing as to whether a blank region continues below the subject key code).

That is, as shown in FIG. 4B, with the flow of the modified example, in a case where it is judged that the subject key code is detected at the judgment of S120 (in a case of “Yes”), the subject judgment unit 21f judges as to whether the data below the subject key code are the data of the return code only or the combination of the blank region data and the return code with respect to the line data under processing in which the subject key code is detected (S126).

In a case where it is judged that the data below the subject key code are the data of the return code only or the combination of the blank region data and the return code at the judgment of S126 (in a case of “Yes”), the processing proceeds to S130, because the line data under processing are the line data possibly containing the editing subject data. On the other hand, in a case where it is judged that the data below the subject key code are not the data of the return code only or the combination of the blank region data and the return code at the judgment of S126 (in a case of “No”), the processing proceeds to S127.

In a case where it is judged that the data below the subject key code are not the data of the return code only or the combination of the blank region data and the return code at the judgment of S126 (in a case of “No”), the subject judgment unit 21f further judges as to whether the portion above the subject key code is the blank region with respect to the line data under processing in which the subject key code is detected (S127).

In a case where it is judged that the portion above the subject key code is the blank region at the judgment of S127 (in a case of “Yes”), the processing proceeds to S130, because the line data under processing are the line data possibly containing the editing subject data. On the other hand, in a case where it is judged that the portion above the subject key code is not the blank region (in a case of “No”), the processing proceeds to S135, because the line data under processing are the line data, as not being the subject, impossibly containing the editing subject data.

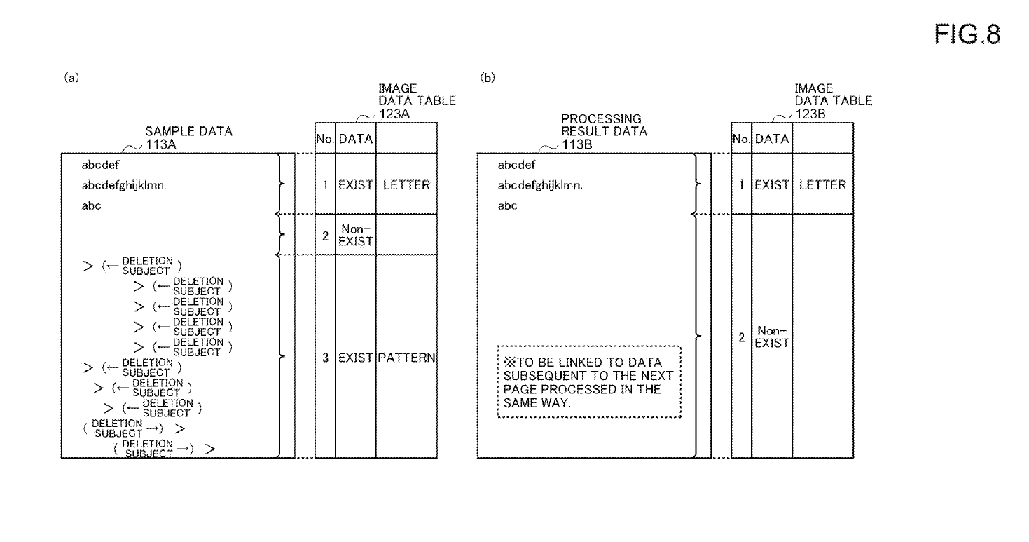

The information processing system 1 can remove such a targeted line in which the blank region exists not only below the subject key code “>” but also above that, chiefly from the image data. The information processing system 1 therefore can do, e.g., the processing shown in FIG. 8 as an example.

FIG. 8 is a diagram showing a processing example of the information processing system according to the first embodiment. FIG. 8(a) shows preprocessing printing sample data 113A and an image data table 123A showing its structural contents. FIG. 8(b) shows post-processing printing sample data 113B and an image data table 123B showing its structural contents.

In the example shown in FIG. 8, the post-processing processing result data 113B have the data of ten lines of “No. 3” of the image data table 123A shown in FIG. 8(a) deleted in comparison with the pre-processing printing sample data 113A.

With the image data, line indent (printing start position of letters) may be shifted from a problem on application programs or compatibility of the information processing terminal 10, or from addition of some justifying data by the information processing system 1, printer drivers, or interfaces. The line with a shift of the indent (printing start position of letters) looks in disorder. The information processing system 1 therefore in such a case can remove lines of the line data having shifted indents by rendering the pattern data in combination of the subject key code and the blank region data as other than the above, form the editing subject data.

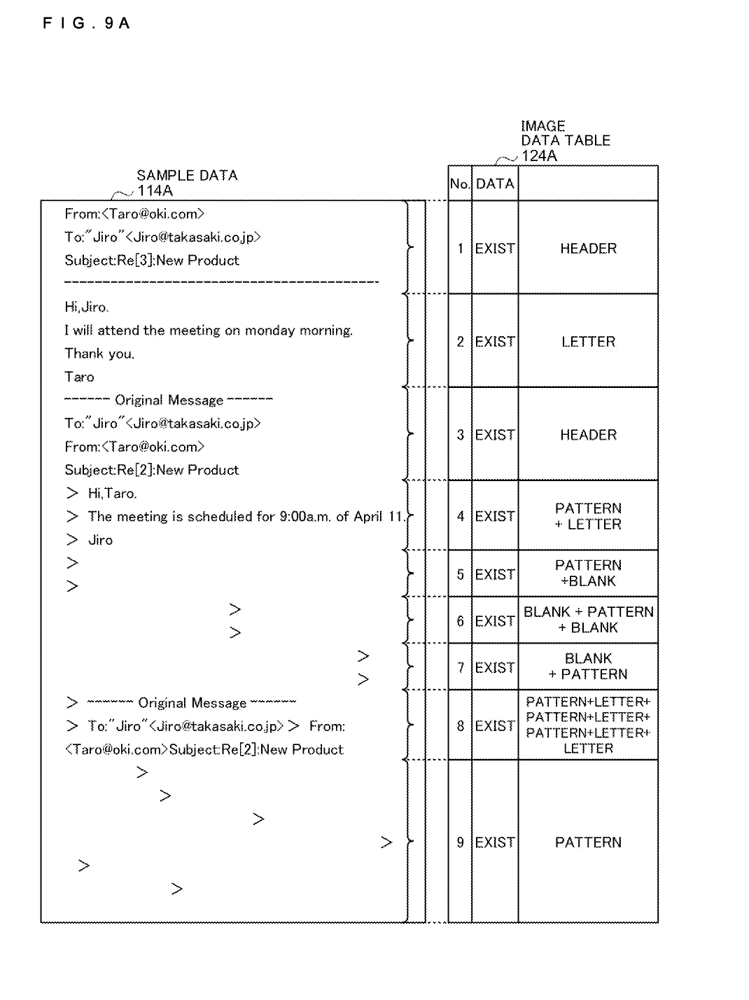

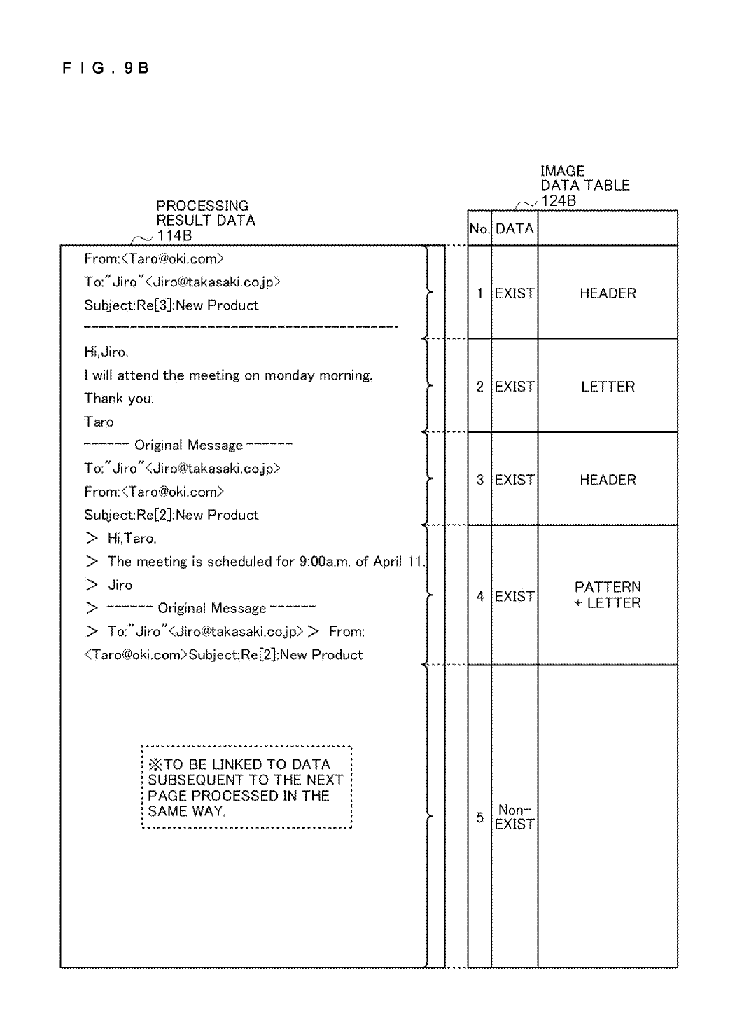

For example, the information processing system 1 can perform the processing shown in FIG. 9A and FIG. 9B as an example. FIG. 9A and FIG. 9B are diagrams showing processing examples of the information processing system according to the first embodiment, respectively. FIG. 9A shows preprocessing printing sample data 114A and an image data table 124A showing its structural contents. FIG. 9B shows post-processing printing sample data 114B and an image data table 124B showing its structural contents.

In the examples shown in FIG. 9A and FIG. 9B, the post-processing processing result data 114B (see, FIG. 9B) have the data of two lines of “No. 5,” the data of two lines of “No. 6,” the data of two lines of “No. 7”, the data of six lines of “No. 9” of the image data table 124A shown in FIG. 9A deleted in comparison with the pre-processing printing sample data 114A (see, FIG. 9A).

As shown in FIG. 9A, the pre-processing printing sample data 114A are added with the sign “>” by repeating replying transmissions, include plural lines made of only combinations of the sign “>” and the blank region data, and have the line indent (printing start position of letters) shifted at a part of the lines. Therefore, many redundant data are occurring.

To the contrary, as shown in FIG. 9B, the post-processing processing result data 114B largely delete the redundant data. In the examples shown in FIG. 9A and FIG. 9B, the information processing system 1 can reduce the line data equal to or more than 30% of the one page as the editing subject data to be the redundant data.

The information processing system 1 thus can reduce the data amount of the image data to be printed with further good efficiency by performing the removing processing of the redundant data to the image data along the flow shown in FIG. 4B. The information processing system 1 therefore can save the resources of the printing medium to be used, with good efficiency more than that during operation of the flow shown in FIG. 4A. The information processing system 1 can also save the resources of not only the printing medium but also such as developer (toner) and electric power, etc. with further good efficiency.

The information processing system 1 can make the image data of the subsequent page or below link to the image data of the previous page where image data exist for plural pages. The information processing system 1 can condense the image data of plural pages into single page data by linking the image data of the subsequent page or below to an empty region of the previous page.

Such processing (hereinafter referred to as “condensing processing”) can be realized by, e.g., the following way. The information processing system 1 performs processing of routines shown in FIG. 4A and FIG. 4B to the image data of the plural pages and memorizes post-processing image data retrieved through this operation in the memory unit 22 or memory unit 21. In the information processing system 1, when the processing of routines shown in FIG. 4A and FIG. 4B to the image data of the plural pages ends, the editing unit 21g or the editing unit 11g reads out the post-processing image data of the plural pages and makes a linkage mutually to the post-processing image data of the plural pages. With this operation, the condensing processing is realized.

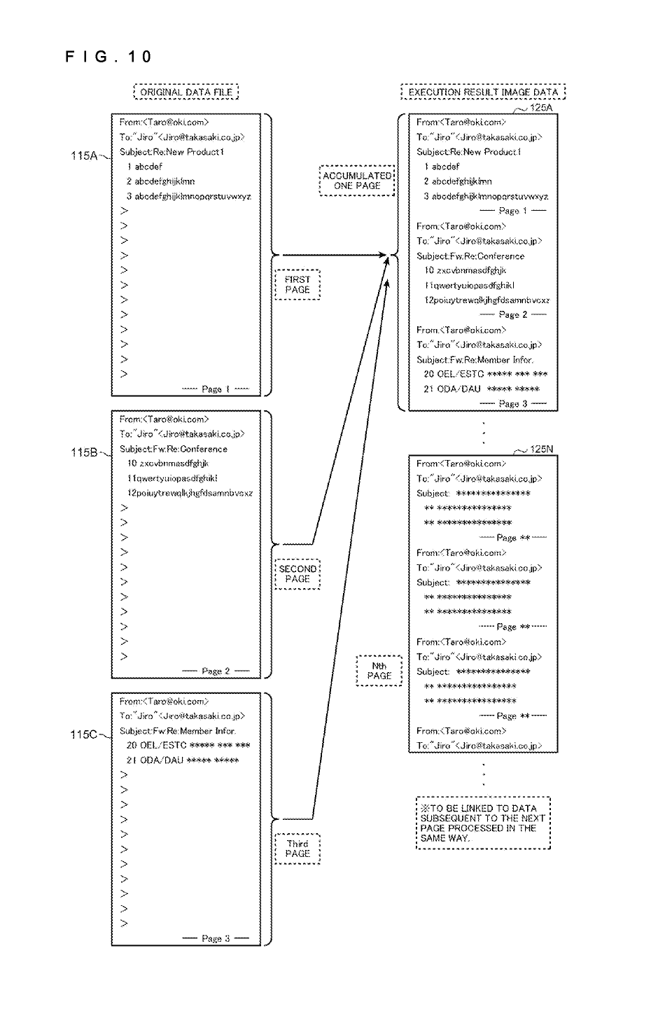

The information processing system 1 for example can do processing shown in FIG. 10 as an example. FIG. 10 is a diagram showing a processing example of the information processing system according to the first embodiment. FIG. 10 shows that the information processing system 1 condenses pre-processing printing sample data of three pages into post-processing processing result data of a single page (herein, execution result image data 125A) by performing deleting processing of the targeted line as the removing processing of the redundant data to the preprocessing printing sample data of three pages (herein original data files 115A, 115B, 115A). With this operation, in the example shown in FIG. 10, the information processing system 1 can save the resources necessary for printing two pages. Therefore, the information processing system 1 can obtain large saving effects on resources from the entire printing job data.

In the first embodiment, it is assumed and described that the system has a structure that the image data to be handled are image of emails transmitted and received among plural persons and include past texts and that it is a case that blank region data as redundant data are removed from the past texts of the emails. The removing processing of the redundant data, however, is not limited to this manner.

For example, the information processing system 1 is used in a case where printing a particular format produced by a system exclusive for users or a case where data produced with a certain application program are converted into data of the different kind (or namely, spread sheet data produced with Excel (registered trademark) or the like are converted into text data viewable with Word (registered trademark)). In such a situation, blank region data or unnecessary letter data occurring from compatible noises or the like may be mingled in the data to be used. Those blank region data or unnecessary letter data become the redundant data.

The information processing system 1 can delete those blank region data or unnecessary letter data by performing the removing processing of the redundant data shown in FIG. 4A or FIG. 4B where the user considers in advance those blank region data and unnecessary letter data and registers those in advance in the information processing system 1 as the subject key code or editing subject data. The information processing system 1 can obtain a large reduction effect on the resources over the entire printing job data in the same way in this situation.

It is to be noted that the information processing system 1 changes operation of the subject judgment unit 11f or 21f as follows, between a case of operation removing the blank region data from the past text and a case of operation other than above.

Where operating to remove blank region data from the past text, the information processing system 1 designates the sign “>” given at the past text portion as the particular letter. The subject judgment unit 11f or 21f identifies the editing subject data by rendering the sign “>” the subject key code and combining automatically the subject key code “>” and the blank region data, and judges as to whether the editing subject data are contained in the line data.

To the contrary, where operating in a way other than removing blank region data from the past text, the information processing system 1 designates a letter (including a sign) other than the sign “>” as the particular letter. In this situation, the subject judgment unit 11f or 21f renders the designated particular letter as the editing subject data if the control program does not define anything, and judges as to whether the line data contains the designated particular letter as the editing subject data.

The information processing system 1 thus formed can identify the editing subject data based on the subject key code and can detect the editing subject data as the redundant data, by setting the particular letter data (including pattern data of the particular string) judged as unnecessary portion by the user as the subject key code in advance. The information processing system 1 therefore can remove the redundant data unnecessary for users.

With this operation, the information processing system 1 can reduce, e.g., the data amount of the image data to be printed during printing. The information processing system 1 therefore can save the resources of printing medium (paper) more than the conventional information processing system. The information processing system 1 can save not only the printing medium but also the resources such as developer (toner) and electric power. The printed images become easily viewed because the redundant data are removed. Accordingly, the information processing system 1 can print images readily viewed by users.

As described above, according to the information processing system 1 of the first embodiment, the redundant data for user can removed. The information processing system 1, therefore, can save the printing medium (paper) to be used more than the conventional information processing system and can save the resources such as developer (toner) and electric power more than the conventional information processing system. According to the information processing system 1, the system can print images readily viewed by users.

### Second Embodiment

An information processing system 1B according to the second embodiment is different, in comparison with the information processing system 1 according to the first embodiment, in a view to a point that the data size of the targeted line is reduced by deleting the blank region data with remaining only the subject key code from the targeted line containing the editing subject data as the redundant data.

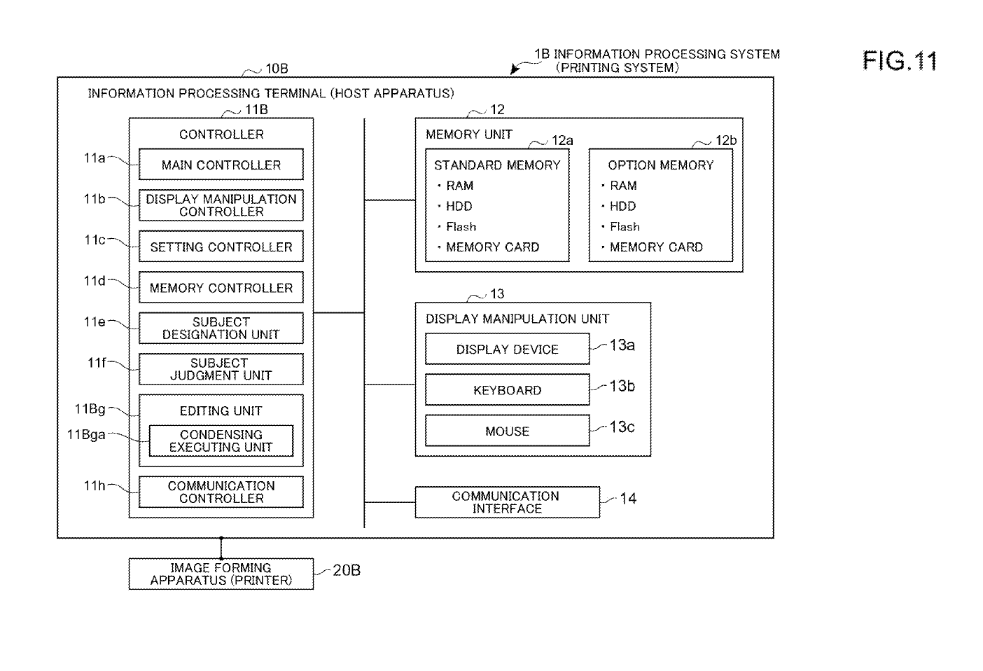

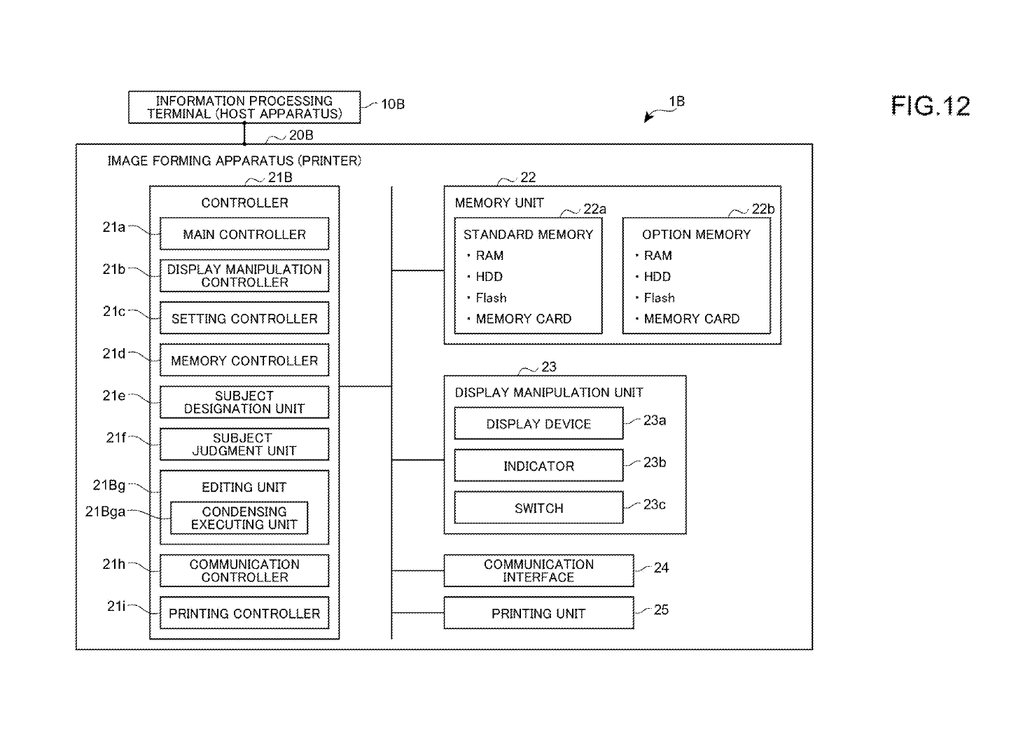

Hereinafter, referring to FIG. 11 and FIG. 12, the structure of the information processing system 1B according to the second embodiment is described. FIG. 11 is a diagram showing the structure of the information processing terminal 10B according to the second embodiment. FIG. 12 is a diagram showing the structure of the image forming apparatus 20B according to the second embodiment.

The information processing terminal 10B is a host apparatus of the image forming apparatus 20B, or is such as, e.g., a personal computer, and a server, in substantially the same way as the information processing terminal 10 according to the first embodiment. The information processing terminal 10B is different, in comparison with the information processing terminal 10 according to the first embodiment, in a view to having an editing unit 11Bg in lieu of the editing unit 11g according to first embodiment.

The editing unit 11Bg is a functioning means for editing image data, in substantially the same way as the editing unit 11g according to the first embodiment. The editing unit 11Bg performs the removing processing of the redundant data to the line data of the targeted line judged as containing the editing subject data by the subject judgment unit 11f, in substantially the same way as the editing unit 11g according to the first embodiment. The editing unit 11Bg is different, in comparison with the editing unit 11g according to the first embodiment, which is having the deletion executing unit 11ga, in a view to having a reduction executing unit 11Bga.

The reduction executing unit 11Bga is a functioning means for deleting the blank region data with remaining the subject key code from the targeted line containing the editing subject data as redundant data. The reduction executing unit 11Bga reduces the data size of the targeted line by performing such processing during the removing processing of the redundant data to the image data. The reduction executing unit 11Bga also deletes the return code of the previous line at the deletion processing of the second time or later where the deletion processing of the blank region data is repetitively performed.

The image forming apparatus 20 is an apparatus for making printing based on image data, such as, e.g., printer, multifunction printer or peripheral (MPF), and photocopier, in substantially the same way as the image forming apparatus 20 according to the first embodiment. The image forming apparatus 20B is different, in comparison with the image forming apparatus 20 according to the first embodiment, in a view to having an editing unit 21Bg in lieu of the editing unit 21g according to first embodiment.

The editing unit 21Bg is a functioning means for editing image data, in substantially the same way as the editing unit 21g according to the first embodiment. The editing unit 21Bg performs the removing processing of the redundant data to the line data of the targeted line judged as containing the editing subject data by the subject judgment unit 21f, in substantially the same way as the editing unit 21g according to the first embodiment. The editing unit 21Bg according to the second embodiment is different, in comparison with the editing unit 21g according to the first embodiment, which is having the deletion executing unit 21ga, in a view to having a reduction executing unit 21Bga.

The reduction executing unit 21Bga is a functioning means for deleting the blank region data with remaining the subject key code from the targeted line containing the editing subject data as redundant data. The reduction executing unit 21Bga reduces the data size of the targeted line by performing such processing during the removing processing of the redundant data to the image data. The reduction executing unit 21Bga also deletes the return code of the previous line at the deletion processing of the second time or later where the deletion processing of the blank region data is repetitively performed.

With the structure described above, the information processing system 1B performs reduction processing as the removing processing of the redundant data to the image data with either of the information processing terminal 10B and the image forming apparatus 20B when images of the image data are printed.

The removing means of the redundant data of the information processing terminal 10B (the subject designation unit 11e, the subject judgment unit 11f, and the editing unit 11Bg) and the removing means of the redundant data of the image forming apparatus 20B (the subject designation unit 21e, the subject judgment unit 21f, and the editing unit 21Bg) serve for the same function to each other. The “removing processing of the redundant data” according to the second embodiment can be done at either of the information processing terminal 10B and the image forming apparatus 20B.

The removing means of the redundant data can share the processing role between the information processing terminal and the image forming apparatus or among those and a functioning means not shown, if the same function can be realized. Accordingly the structure of the information processing system 1B is not limited to the structure shown in FIG. 11 and FIG. 12.

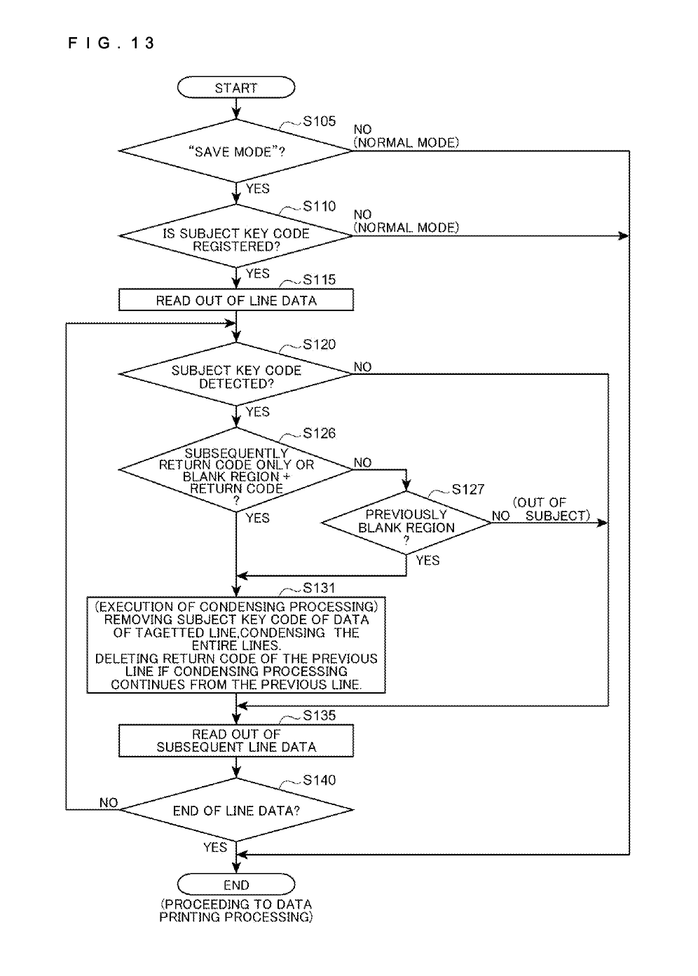

Hereinafter, referring to FIG. 13, the operation of the information processing system 1B according to the second embodiment is described. FIG. 13 is a flowchart showing the operation of the information processing system 1B according to the second embodiment.

As shown in FIG. 13, the operation of the information processing system 1B according to the second embodiment is different, in comparison with the operation of the information processing system 1 according to the first embodiment (see, FIG. 4B), which performs the processing of S130, in a view to performing the processing of S131 in lieu of the processing of S130.

That is, as shown in FIG. 13, with the information processing system 1B according to the second embodiment, the reduction executing unit 21Bga of the editing unit 21Bg deletes the blank region data with remaining the subject key code from the line data under processing having the editing subject data as the redundant data, in a case where it is judged that the data below the subject key code are the data of the return code only or the data in combination of the blank region data and the return code at the judgment of S126 (in a case of “Yes”), or in a case where it is judged that the data above the subject key code are the blank region data at the judgment of S127 (in a case of “Yes”). With this operation, the reduction executing unit 21Bga reduces the data size of the line data under processing (S131).

It is to be noted that if the reduction processing continues from the previous line at that time, the reduction executing unit 21Bga deletes the return code of the previous line. For example, in a case where the deletion processing of the blank region data is repetitively performed, the reduction executing unit 21Bga deletes the return code of the previous line at the deletion processing of the second time or later.

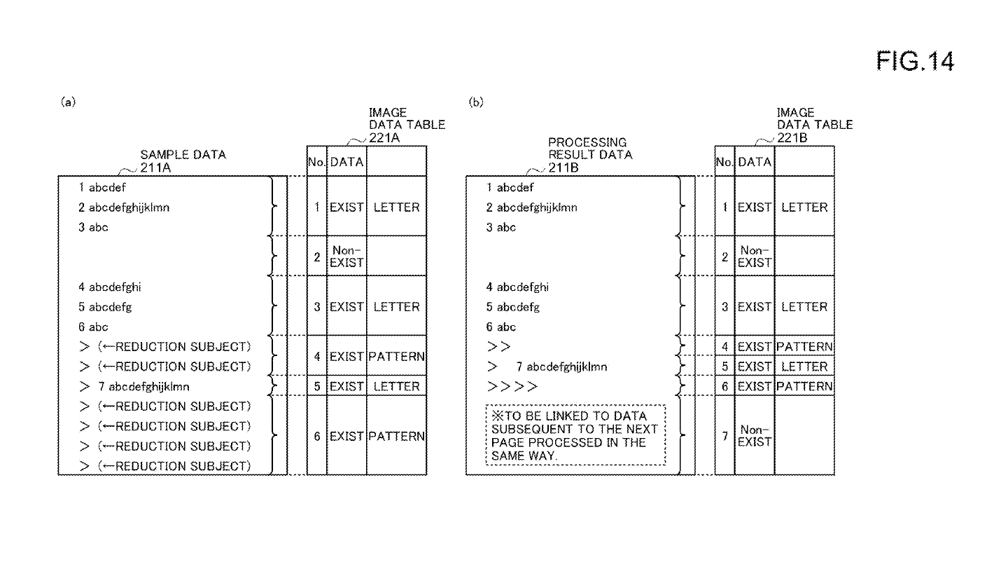

With this operation, the information processing system 1B can reduce the data size of the targeted line containing the subject key code as the redundant data. The information processing system 1B further can notify the user of the number of the reduced targeted lines (or namely, the number of the subject key code detected in the reduced region) because deleting the redundant data as to make the subject key code remain in the reduced region. For example, the information processing system 1B can perform the processing shown in FIG. 14 as an example.

FIG. 14 is a diagram showing a processing example of the information processing system according to the second embodiment. FIG. 14(a) shows preprocessing printing sample data 211A and an image data table 221A showing its structural contents. FIG. 14(b) shows post-processing printing sample data 211B and an image data table 221B showing its structural contents.

In the example shown in FIG. 14, the post-processing processing result data 211B have the data of two lines of “No. 4” and the data of the four lines of “No. 6” of the image data table 221A shown in FIG. 14(a) deleted in comparison with the pre-processing printing sample data 211A.

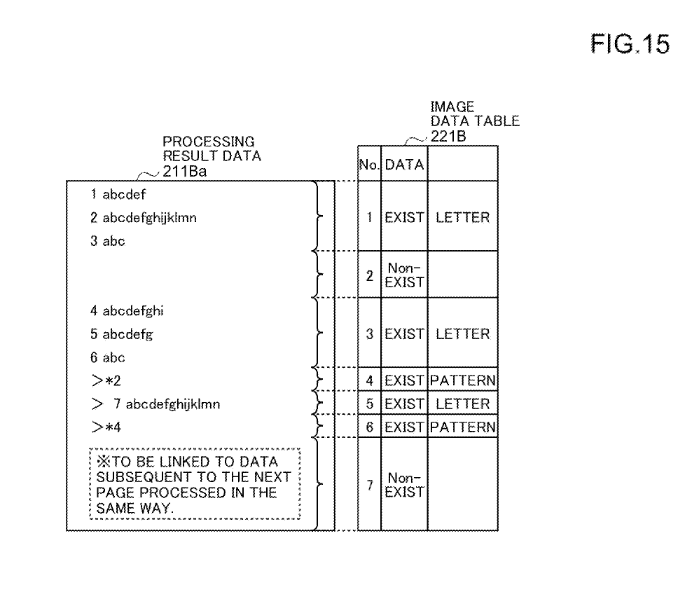

The information processing system 1B can obtain the processing result data 211Ba shown in FIG. 15 if the processing of S131 in FIG. 13, or processing in which return code is deleted from the previous line where the reduction continues from the previous line, is changed. FIG. 15 is a diagram showing the processing example of the information processing system according to the second embodiment.

FIG. 15 shows a structure of the processing result data 211Ba consequently obtained from the reduction processing according to the modified example for the preprocessing printing sample 211A shown in FIG. 14(a). The information processing system 1B herein, with respect to the region subjecting to the reduction processing of the preprocessing printing sample data 211A shown in FIG. 14A, counts up the number of the subject key codes in the region, as the reduction processing according to the modified example, and converts the subject key codes in the region into the pattern data combining the subject key codes and the counted number data.

In the examples shown in FIG. 14 and FIG. 15, the post-processing processing result data 211Ba (see, FIG. 15) are reduced (or condensed) to the data having a single line with an indication of “>*2” from the data of the two lines of “No. 4” of the image data table 221A shown in FIG. 14(a) and reduced (or condensed) to the data having a single line with an indication of “>*4” from the data of the four lines of “No. 6” of the image data table 221A shown in FIG. 14(a), in comparison with the preprocessing printing sample data 211A (see FIG. 14(a)).

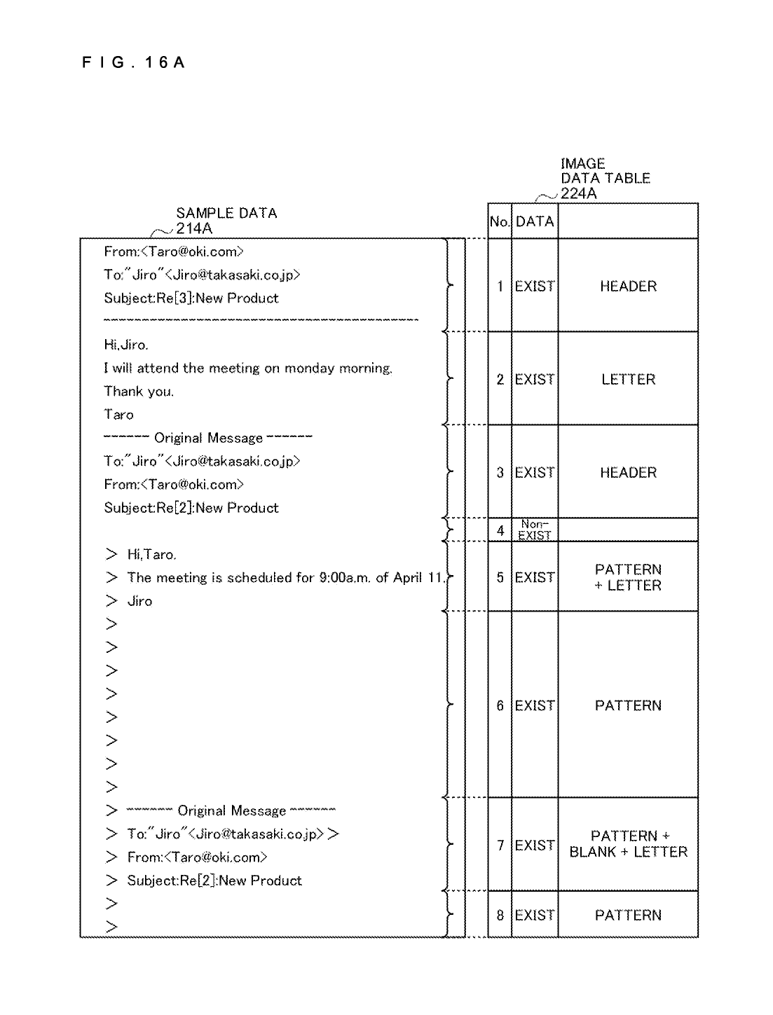

The information processing system 1B thus formed can perform the processing shown in FIG. 16A and FIG. 16B as an example. FIG. 16A and FIG. 16B are diagrams showing processing examples of the information processing system according to the second embodiment, respectively. FIG. 16A shows preprocessing printing sample data 214A and an image data table 224A showing its structural contents. FIG. 16B shows post-processing printing sample data 214B and an image data table 224B showing its structural contents.

In the example shown in FIG. 16A and FIG. 16B, the post-processing processing result data 214B (see FIG. 16B) have the data of eight lines of “No. 6” and the data of two line of “No. 8” of the image data table 224A shown in FIG. 16A, reduced in comparison with the pre-processing printing sample data 214A (see FIG. 16A).

As shown in FIG. 16A, the pre-processing printing sample data 214A are added with the signs “>” by repeating of return transmissions and has a structure including plural lines made of only combinations of the sign “>” and the blank region data. In the pre-processing printing sample data 214A, many redundant data are therefore occurring.

To the contrary, as shown in FIG. 16B, the post-processing processing result data 214B largely delete the redundant data. In the examples shown in FIG. 16A and FIG. 16B, the information processing system 1B can reduce the line data equal to or more than 30% of the one page as the editing subject data to be the redundant data.

The information processing system 1B, in substantially the same way as the information processing system 1 according to the first embodiment, can make the image data of the subsequent page or below link to the image data of the previous page where image data exist for plural pages. The information processing system 1B can condense the image data of plural pages into single page data by linking the image data of the subsequent page or below to an empty region of the previous page.

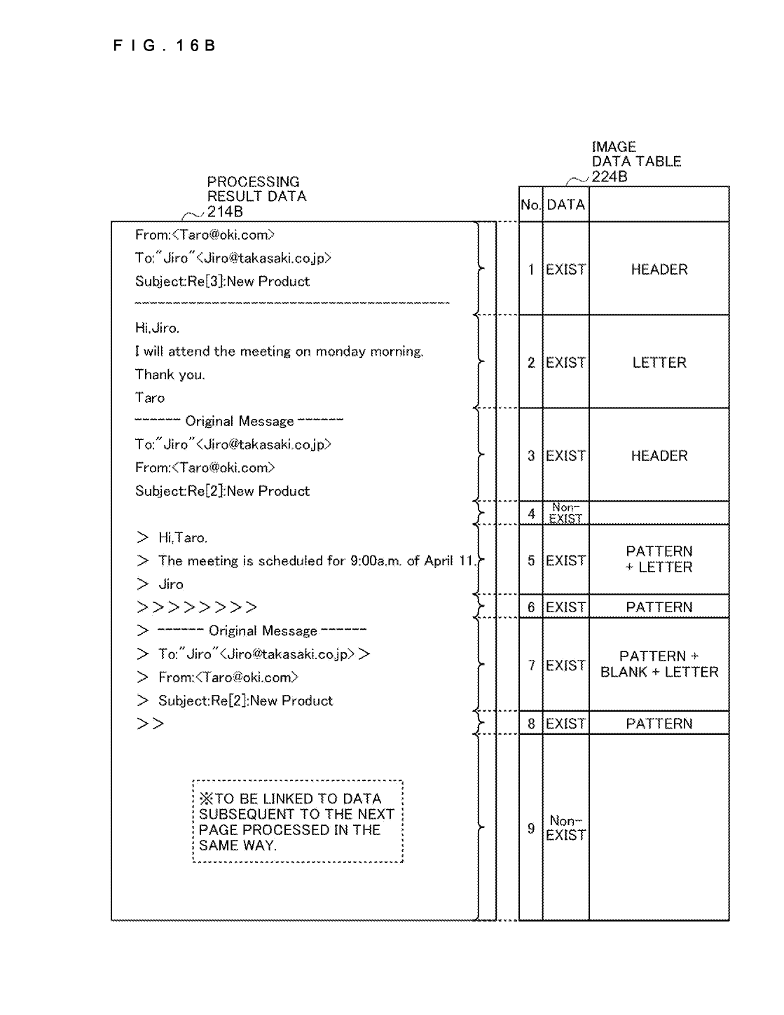

For example, the information processing system 1B can perform the processing shown in FIG. 17 as an example. FIG. 17 is a diagram showing a processing example of the information processing system according to the second embodiment. FIG. 17 shows that the information processing system 1B condenses the preprocessing printing sample data of three pages into the post-processing processing result data (herein, execution result image data 225A) of a single page by performing the reduction processing of the targeted lines as the removing processing of the redundant data to the preprocessing printing sample data of three pages (herein, original data files 215A, 215B, 215C). With this operation, the information processing system 1B can save the resources necessary for printing of two pages. The information processing system 1B therefore can obtain a good resource saving effect over the entire printing job data.

The information processing system 1B thus formed can remove the redundant data unnecessary for users, which includes the blank region data, in substantially the same way as the information processing system 1 according to the first embodiment. With this operation, the information processing system 1B can reduce, e.g., the data amount of the image data to be printed during printing. The information processing system 1B therefore can save the resources of printing medium (paper) more than the conventional information processing system, in substantially the same way as the information processing system 1 according to the first embodiment. The information processing system 1B can save not only the printing medium but also the resources such as developer (toner) and electric power.

The printed images become easily viewed because the redundant data are removed. Furthermore, the information processing system 1B removes the redundant data so that the subject key codes remain in the condensed region, so that the system 1B can notify the users of the number of the condensed targeted lines (or namely, the number of the subject key codes detected in the condensed region). Accordingly, the information processing system 1 can print images readily viewed by users.

As described above, according to the information processing system 1B of the second embodiment, the redundant data for user can removed, in substantially the same way as the information processing system 1 according to the first embodiment. The information processing system 1B, therefore, can save the printing medium (paper) to be used more than the conventional information processing system and can save the resources such as developer (toner) and electric power more than the conventional information processing system. According to the information processing system 1B, the system can print images readily viewed by users. Moreover, according to the information processing system 1B, the system can notify the users of the number of the condensed targeted lines (or namely, the number of the subject key codes detected in the condensed region).

### Third Embodiment

An information processing system 1C according to the third embodiment is different, in comparison with the information processing system 1 according to the first embodiment, in a view to a point that the subject key code can be set in a plural number and that an extension modifier extending the definition of the editing subject data can be set.

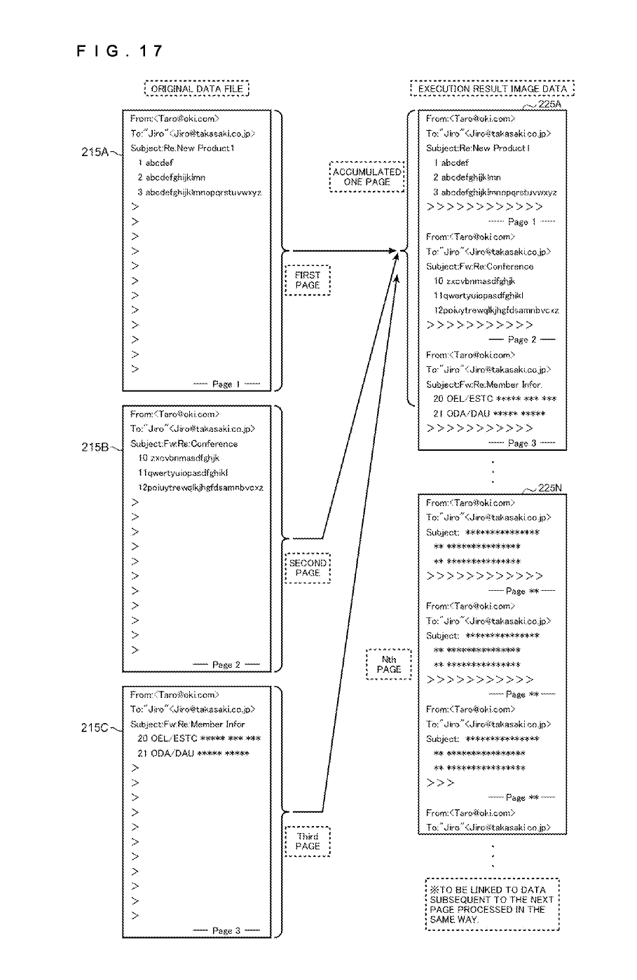

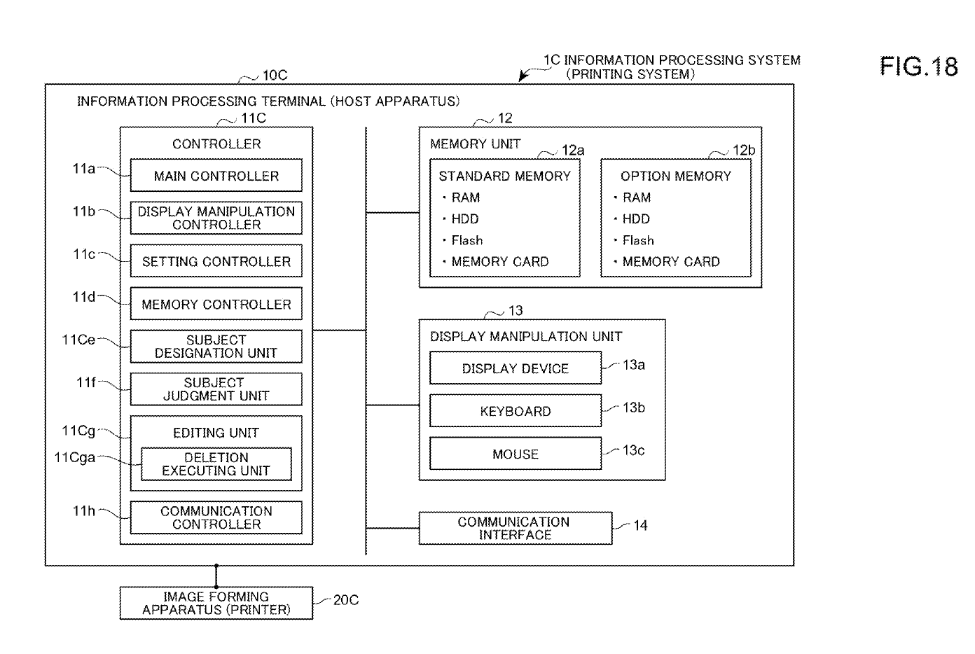

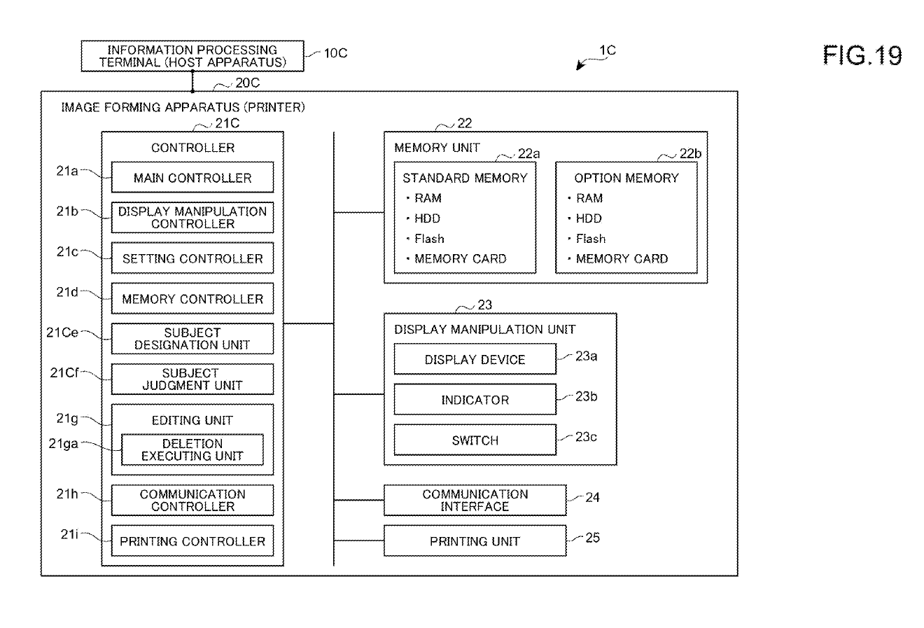

Hereinafter, referring to FIG. 18 and FIG. 19, the structure of the information processing system 1C according to the third embodiment is described. FIG. 18 is a diagram showing the structure of the information processing terminal 10C according to the third embodiment. FIG. 19 is a diagram showing the structure of the image forming apparatus 20C according to the third embodiment.

The information processing terminal 10C is a host apparatus of the image forming apparatus 20C, or is such as, e.g., a personal computer, and a server, in substantially the same way as the information processing terminal 10 according to the first embodiment. The information processing terminal 10C is different, in comparison with the information processing terminal 10 according to the first embodiment (see FIG. 2), in a view to having a subject designation unit 11Ce and a subject judgment unit 11Cf in lieu of the subject designation unit 11e and the subject judgment unit 11f according to first embodiment.

The subject designation unit 11Ce is a functioning means for receiving the particular letter (including a pattern of the particular string) designated by the user, in substantially the same way as the subject designation unit 11e according to the first embodiment. The subject designation unit 11Ce is different, in comparison with the subject designation unit 11e according to the first embodiment, in a view to that the subject key code can be set in a plural number and that the extension modifier extending the definition of the editing subject data can be set.

The subject judgment unit 11Cf is a functioning means for judging as to whether line data of each line forming the image data (here, image data of text data) contain the editing subject data, in substantially the same way as the subject judgment unit 11f according to the first embodiment. The subject judgment unit 11Cf is different, in comparison with the subject judgment unit 11f according to the first embodiment, in which the subject judgment unit 11f according to the first embodiment detects the editing subject data as the redundant data based on the single subject key code designated by the subject designation unit 11e, in a view to that the editing subject data as the redundant data are detected based on condition data where the condition data are set from both of one or more of the subject key codes set by the subject designation unit 11Ce according to the third embodiment and extension modifiers set in association with the respective subject key codes.

The image forming apparatus 20C is an apparatus for printing based on image data, such as, e.g., a printer, a multifunction printer, and a photocopier, in substantially the same way as the image forming apparatus 20 according to the first embodiment. The image forming apparatus 20C is different, in comparison with the information processing terminal 10 according to the first embodiment (see FIG. 2), in a view to having a subject designation unit 11Ce and a subject judgment unit 11Cf in lieu of the subject designation unit 11e and the subject judgment unit 11f according to first embodiment.

The subject designation unit 21Ce is a functioning means for receiving the particular letter (including a pattern of the particular string) designated by the user, in substantially the same way as the subject designation unit 21e according to the first embodiment. The subject designation unit 21Ce is different, in comparison with the subject designation unit 21e according to the first embodiment, in a view to that the subject key code can be set in a plural number and that the extension modifier extending the definition of the editing subject data can be set.

The subject judgment unit 21Cf is a functioning means for judging as to whether line data of each line forming the image data (here, image data of text data) contain the editing subject data, in substantially the same way as the subject judgment unit 21f according to the first embodiment. The subject judgment unit 21Cf is different, in comparison with the subject judgment unit 21f according to the first embodiment, in which the subject judgment unit 21f according to the first embodiment detects the editing subject data as the redundant data based on the single subject key code designated by the subject designation unit 21e, in a view to that the editing subject data as the redundant data are detected based on condition data where the condition data are set from both of one or more of the subject key codes set by the subject designation unit 21Ce according to the third embodiment and extension modifiers set in association with the respective subject key codes.

With this structure, the information processing system 1C performs the deletion processing as removing processing of the redundant data to the image data at either of the information processing terminal 10C and the image forming apparatus 20C when the images of the image data are printed.

It is to be noted that the removing means of the redundant data of the information processing terminal 10C (or namely, the subject designation unit 11Ce, the subject judgment unit 11Cf, and the editing unit 11g) and the removing means of the redundant data of the image forming apparatus 20C (or namely, the subject designation unit 21Ce, the subject judgment unit 21Cf, and the editing unit 21g) serve for the same function. Accordingly, the “removing processing of the redundant data” can be done at either of the information processing terminal 10C and the image forming apparatus 20C.

The removing means of the redundant data can share the processing role between the information processing terminal and the image forming apparatus or among those and a functioning means not shown, if the same function can be realized. Accordingly the structure of the information processing system 1C is not limited to the structure shown in FIG. 18 and FIG. 19.

The information processing system 1 according to the first embodiment has a structure to set a single particular letter data as the subject key code. To the contrary, the information processing system 1C according to the third embodiment has, e.g., a structure that the subject key code can be set in a plural number and that the extension modifier extending the definition of the editing subject data can be set in association with the respective subject key codes, as shown in FIG. 27. FIG. 27 is a diagram showing an example of a setting screen in a case where the subject key codes used in the third embodiment are set.

It is assumed and described that it is a case that a user sets the subject key codes and the extension modifiers on the setting screen 602 of the subject key code of the printer driver displayed on the display device 13a of the information processing terminal 10C. Alternatively, the user can set the subject key codes and the extension modifiers by manipulating the display manipulation unit 23 of the image forming apparatus 20C.

In the example shown in FIG. 27, the setting screen 602 of the subject key code of the printer driver displayed on the display device 13a of the information processing terminal 10C has a structure capable of setting definition data extending the definition of the editing subject data (hereinafter, referred to as “extension modifier”) in association with the respective subject key codes.

The subject designation unit 11Ce registers the subject key codes and the extension modifiers in the memory unit 12 where the user sets the subject key codes and the extension modifiers on the setting screen 602. The subject key codes and the extension modifiers registered in the memory unit 12 are informed from the information processing terminal 10C to the image forming apparatus 20C, and are registered in the memory unit 22 of the image forming apparatus 20C. The information processing system 1C uses the data combining the subject key codes and the extension modifiers registered in the memory units 12, 22 as the condition data at a time that the targeted line is detected.

The extension modifier can be set by using a logical operation formula indicated by, e.g., a sign of “+” meaning summation, letters of “and” or a sign of “&” meaning logical conjunction, letters of “or” and a sign of “|” meaning logical disjunction, a sign “$” meaning one letter wildcard, and a sign “*” meaning plural letter wildcard.

The subject key code is indicated by placing square brackets immediately above and below of the subject key code. For example, where the subject key code is indicated with “abc” and the extension modifier is indicated with “xyz”, and where the extension modifier in association with the subject key code is defined with “abc or xyz,” the extension modifier in association with the subject key code is indicated with “[abc] or [xyz]” or “[abc]|[xyz].”

The information processing system 1C makes the data in combination of the subject key codes and the extension modifiers as condition data where the subject key codes and the extension modifiers are set, detects the targeted line matching to the condition data, and performs the removing processing of the redundant data (herein the deletion processing) to the targeted line.

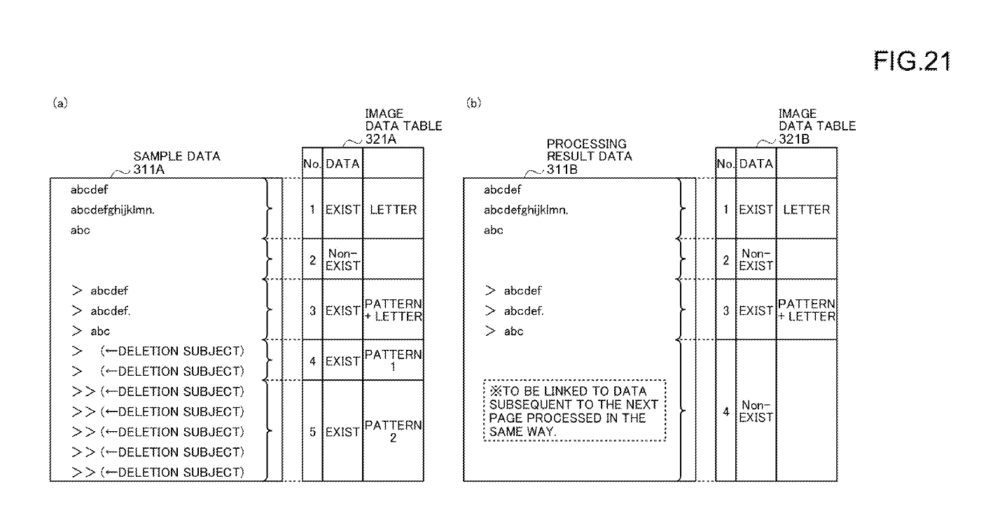

Herein, it is assumed and described that the information processing system 1C deletes lines containing a single sign of “>” or “>>” not accompanying with any letter located immediately above or below the “subject key code” as shown in FIG. 21. FIG. 21(a) is a diagram showing a processing example of the information processing system according to the third embodiment. FIG. 21(a) shows preprocessing printing sample data 311A and an image data table 321A showing its structural contents. FIG. 12(b) shows post-processing printing sample data 311B and an image data table 321B showing its structural contents. FIG. 21 shows an example in a case of deleting the targeted line containing the editing subject data matching to both of the subject key code “> or >>” and the extension modifier set in association with the subject key code.

The user registers “[>] or [>>]” as the subject key code in advance with, e.g., the setting screen 602 of the subject key code of the printer driver (see FIG. 27) in a case where having the information processing system 1C perform the deletion processing shown in FIG. 21. The information processing system 1C can change the setting range of the condition data used for detecting the editing subject data as the redundant data with this operation.

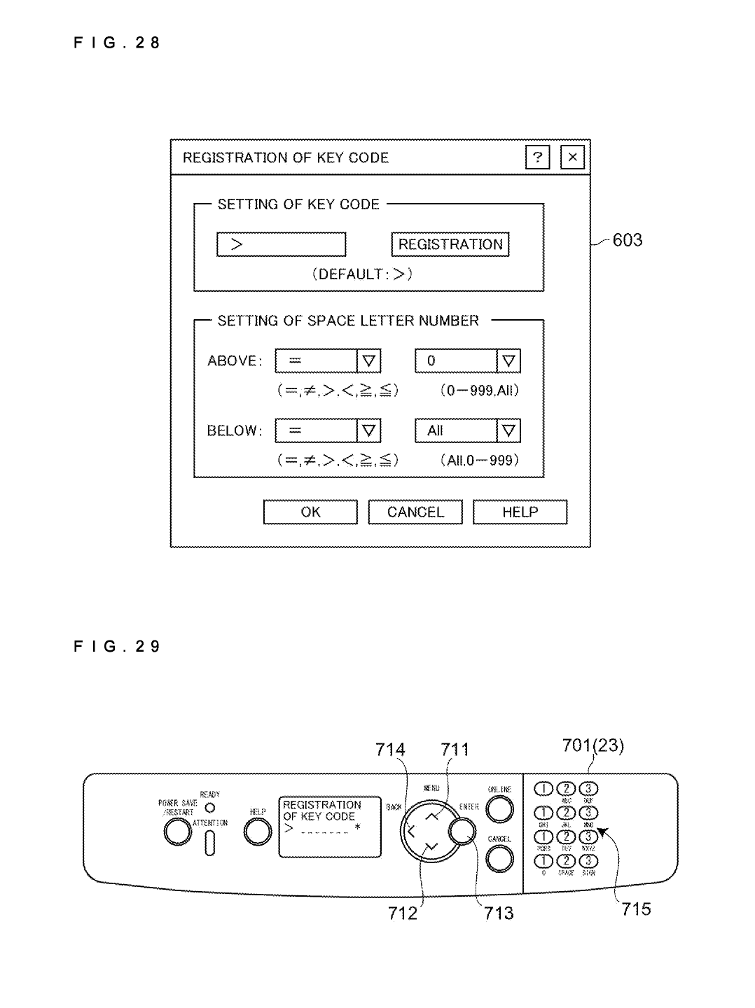

It is be noted that the information processing system 1C according to the third embodiment may have, e.g., a structure that further complicated condition data can be set as shown in FIG. 28. FIG. 28 is a diagram showing an example of a setting screen in a case where the subject key code used in the third embodiment is set. In the example shown in FIG. 28, the setting screen 603 of the subject key code of the printer driver has a structure to set the number of space strings located either or both of above and below the subject key code as the extension modifier. The “number of space strings” may be defined by the size of the blank region.

In the example shown in FIG. 28, on the setting screen 603, an entry field on an upper stage is a field for setting the subject key coded, and an entry field on a lower stage is a field for setting the extension modifier in association with the subject key code.

The subject key code is set in the entry field on the upper stage of the setting screen 603. The setting screen 603 may set the subject key code and the extension modifier at the field for setting the subject key code (the field on the upper stage) in substantially the same way as the setting screen 602 shown in FIG. 27.

In the entry field on the lower stage of the setting screen 603, numerical value data representing the number of the space strings (or size of the blank region) are set in the entry field on a right side, and the signs such as equal sign or sign of inequality are set in the entry field on a left side, for each of “above” and “below” the subject key code as the extension modifiers.

The extension modifiers can be set using logical operation formulae for arbitrary numerical values represented by such as, e.g., a sign “=” meaning “equality,” a sign “≠” meaning “inequality,” a sign “>” meaning “greater than,” a sign “<” meaning “less than,” a sign “≧” meaning “greater than or equal to,” and a sign “≦” meaning “less than or equal to.” The setting screen 603 can set the letter number in the blank region located above or below the subject key code “>” as the extension modifier for the subject key code “>.” With this setting, the information processing system 1C can change details of the setting range of the condition data used at a time that the editing subject data serving as the redundant data are detected.

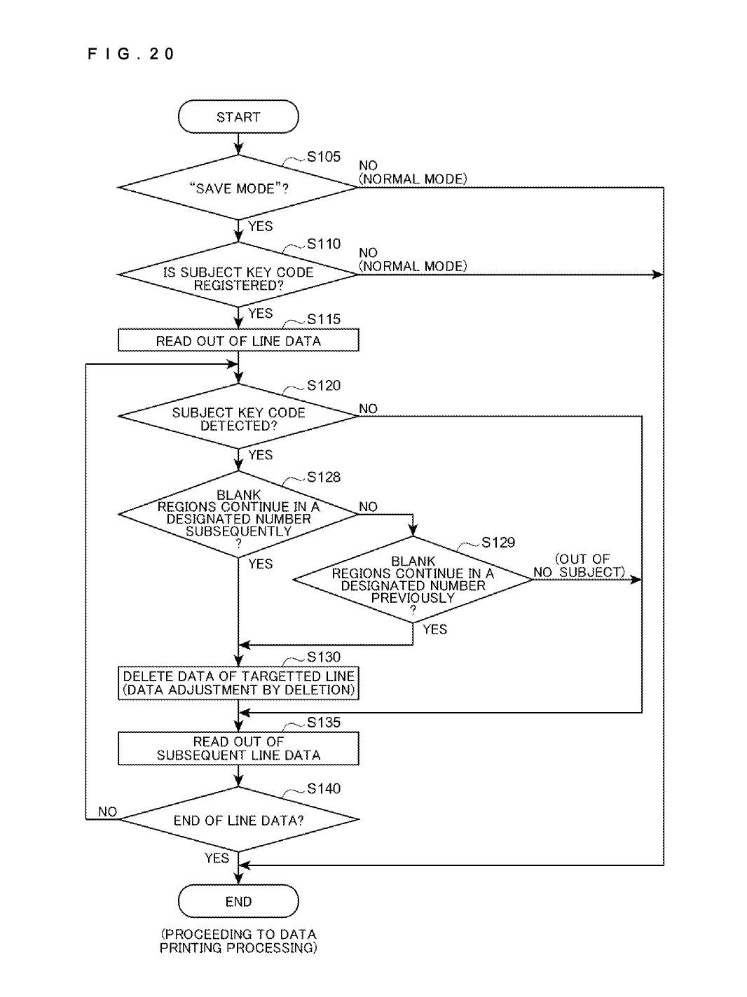

Hereinafter, referring to FIG. 20, the operation of the information processing system 1C according to the third embodiment is described. FIG. 20 is a flowchart showing the operation of the information processing system 1C according to the third embodiment.

As shown in FIG. 20, the operation of the information processing system 1C according to the third embodiment is different, in comparison with the operation of the information processing system 1 according to the first embodiment (see, FIG. 4B), in which the information processing system 1 according to the first embodiment performs the processing of S126 and the processing of S127, in a view to performing the processing of S128 and the processing of S129 in lieu of those processings.

That is, as shown in FIG. 20, in the information processing system 1C according to the third embodiment, in a case where it is judged that the subject key code is detected at the judgment of S120 (in a case of “Yes”), the subject judgment unit 21Cf judges as to whether the blank regions continue in the designated number subsequently to the subject key code in the line data under processing in which the subject key code is detected (S128).

In a case where it is judged that the blank regions continue in the designated number subsequently to the subject key code at the judgment of S128 (in a case of “Yes”), the processing proceeds to S130 because the line data under processing are line data possibly containing the editing subject data. On the other hand, in a case where it is judged that the blank regions do not continue in the designated number subsequently to the subject key code at the judgment of S128 (in a case of “No”), the processing proceeds to S129.

In a case where it is judged that the blank regions do not continue in the designated number subsequently to the subject key code at the judgment of S128 (in a case of “No”), the subject judgment unit 21Cf judges as to whether the blank regions continue in the designated number previously to the subject key code in the line data under processing in which the subject key code is detected (S129).

In a case where it is judged that the blank regions continue in the designated number previously to the subject key code at the judgment of S129 (in a case of “Yes”), the processing proceeds to S130, because the line data under processing are line data possibly containing the editing subject data. On the other hand, in a case where it is judged that the blank regions do not continue in the designated number previously to the subject key code at the judgment of S129 (in a case of “No”), the processing proceeds to S135, because the line data under processing are line data impossibly containing the editing subject data as out of subject.

In a case where it is judged that the blank regions continue in the designated number subsequently to the subject key code at the judgment of S128 (in a case of “Yes”), or in a case where it is judged that the blank regions continue in the designated number previously to the subject key code at the judgment of S129 (in a case of “Yes”), the deletion executing unit 21ga of the editing unit 21g deletes the line data under processing (S130).

In a case where it is judged that the subject key code is not detected at the judgment of S120 (in a case of “No”), or in a case where it is judged that the blank regions do not continue in the designated number previously to the subject key code at the judgment of S129 (in a case of “No”), or subsequently to S130, the subject judgment unit 21Cf reads out the line data subsequent to the image data from the memory unit 22 (S135).

The subject judgment unit 21Cf judges as to whether the line data reach the end (or whether read-out of the line data of the last line reaches the end) (S140). In a case where it is judged that the line data reach the end (or read-out of the line data of the last line reaches the end) at the judgment of S140 (in a case of “Yes”), the processing ends. On the other hand, in a case where it is judged that the line data do not reach the end (or read-out of the line data of the last line does not reach the end) at the judgment of S140 (in a case of “No”) the processing returns to S120. As a result, the image forming apparatus 20C repeats processings of S120 through S140 in this case.

The information processing system 1C thus formed can perform, e.g., the processing shown in above FIG. 21 as an example. As described above, FIG. 21 shows the example in a case of deleting the targeted line containing the editing subject data matching to both of the subject key code “> or >>” (or namely, the subject key code “[>] or [>>]”) and the extension modifier set in association with the subject key code.

In the example shown in FIG. 21, the post-processing processing result data 311B have the data of two lines of “No. 4” and the data of the five lines of “No. 5” of the image data table 321A shown in FIG. 21(a) deleted in comparison with the pre-processing printing sample data 311A.

The designated number of the blank regions used for judgments at S128 and at S129 may be a data size as the blank regions. In such as case, the subject judgment unit 21Cf detects as to whether regions in a constant size continue as the blank regions at the judgments of S128 and S129.

For example, the information processing system 1C can delete the targeted line matching to the conditions such that, e.g., the subject key code is set to the sign “>,” that the letter number of the blank region above the subject key code is set to “zero,” and that the letter number of the blank region below the subject key code is set to “one.”

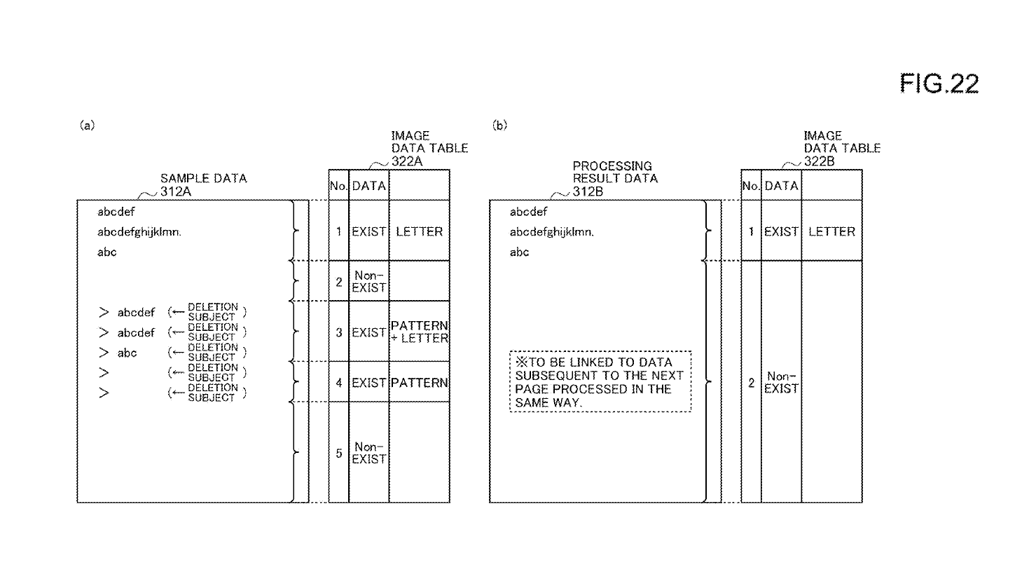

The information processing system 1C can perform, e.g., the processing shown in above FIG. 22 as an example. FIG. 22 is a diagram showing a processing example of the information processing system according to the third embodiment. FIG. 22(a) shows preprocessing printing sample data 312A and an image data table 322A showing its structural contents. FIG. 22(a) shows post-processing printing sample data 312B and an image data table 322B showing its structural contents.

The information processing system 1 according to the first embodiment deletes lines containing the subject key code along the flow shown in FIG. 4A. The information processing system 1 according to the first embodiment, however, cannot delete lines containing string data corresponding to “No. 3” in the image data table 322A shown in FIG. 22(a).

To the contrary, the information processing system 1C according to the third embodiment deletes lines matching the condition data along the flow shown in FIG. 20 where rendering the condition data matching to both of the one or more of the subject key codes and the extension modifiers set in association with the respective subject key codes, which are set with the setting screen 602 shown in FIG. 27 or the setting screen 603 shown in FIG. 28. The information processing system 1C according to the third embodiment therefore can delete the lines containing the string data corresponding to “No. 3” in the image data table 322A shown in FIG. 22(a).

Detection of the lines containing the string data corresponding to “No. 3” in the image data table 322A shown in FIG. 22(a) can be realized by setting the extension modifiers, in association with the subject key codes, in a way that the letter number of the blank region above the subject key code is “zero or more [≧0]” and that the letter number of the blank region below the subject key code is “zero or more [≧0].”

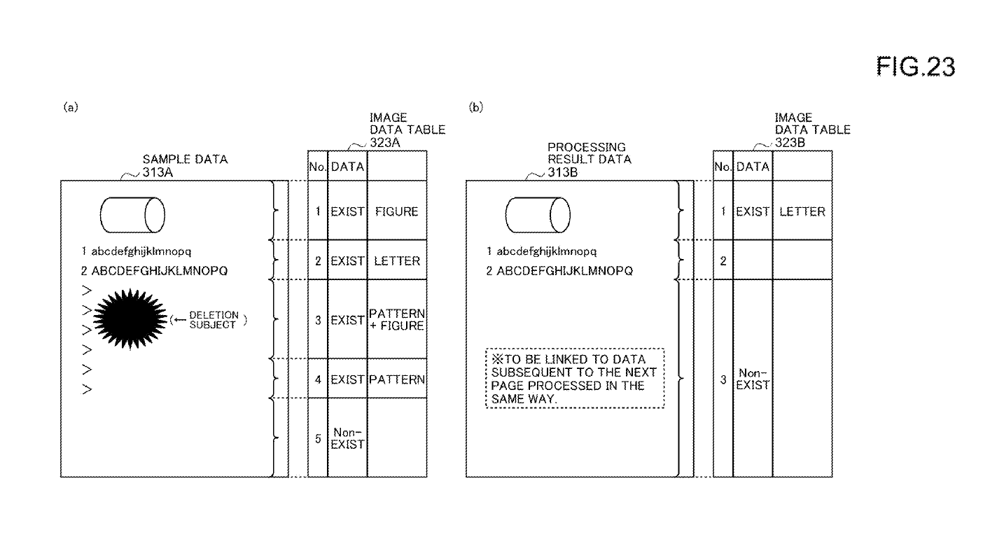

The information processing system 1C can also perform, e.g., the processing shown in above FIG. 23 as an example. FIG. 23 is a diagram showing a processing example of the information processing system according to the third embodiment. FIG. 23(a) shows preprocessing printing sample data 313A and an image data table 323A showing its structural contents. FIG. 23(a) shows post-processing printing sample data 313B and an image data table 323B showing its structural contents.

In the example shown in FIG. 23, the post-processing processing result data 313B have the data of four lines of “No. 3” including figure data and the data of the two lines of “No. 4” of the image data table 323A shown in FIG. 23(a) deleted in comparison with the pre-processing printing sample data 313A.

In the example shown in FIG. 23, the pre-processing printing sample data 313A is structured in including a figure below the subject key code “>.” The user can set the figure as the extension modifier on the setting screen 602 shown in FIG. 27 or the setting screen 603 shown in FIG. 28, where expecting the deletion of the figure. As a result, the information processing system 1C can make data of four lines of “No. 3” including the figure in the image data table 323A as shown in FIG. 23(b).

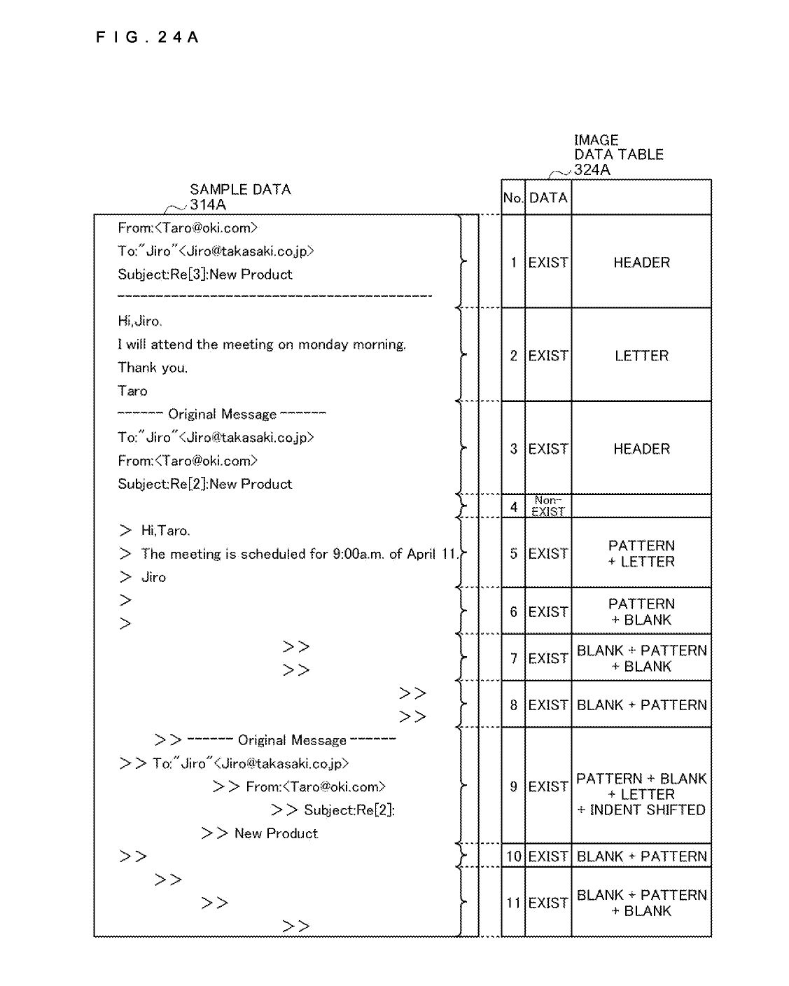

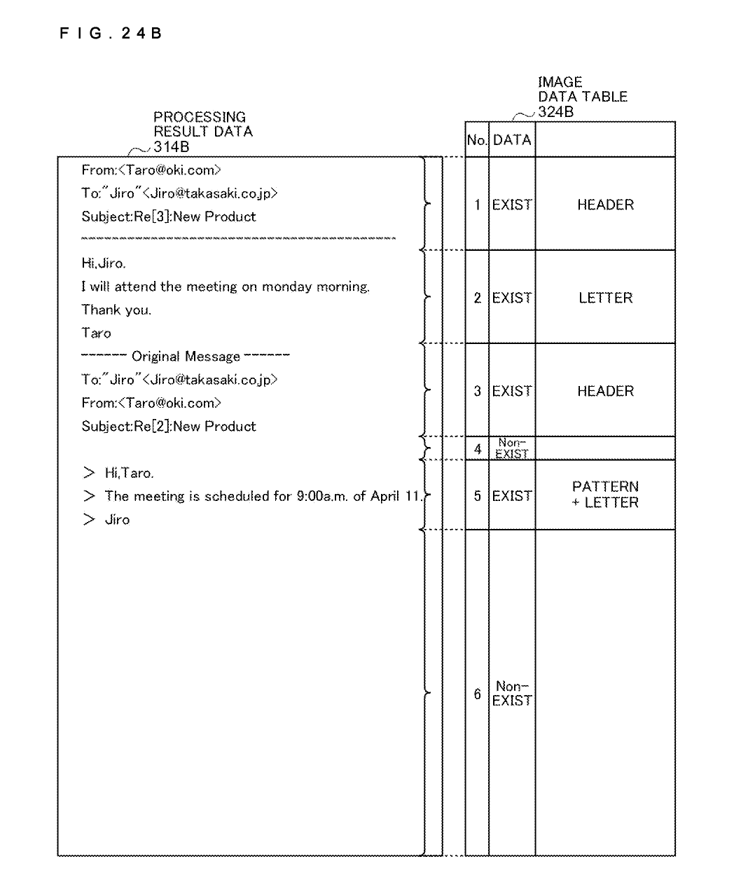

The information processing system 1C can also perform, e.g., the processing shown in FIG. 24A and FIG. 24B as an example. FIG. 24A and FIG. 24B are diagrams, respectively showing a processing example of the information processing system according to the third embodiment. FIG. 24A shows preprocessing printing sample data 314A and an image data table 324A showing its structural contents. FIG. 24B shows post-processing printing sample data 314B and an image data table 324B showing its structural contents.

In the example shown in FIG. 24A, the post-processing processing result data 314B have the data below “No. 6” of the image data table 324A shown in FIG. 24A deleted in comparison with the pre-processing printing sample data 314A. That is, the information processing system 1C deletes the line data of the line with a shifted indent.

Detection of the lines with the shifted indent can be realized by setting the extension modifiers in a way that the subject key code is set to the sign “>>,” that the letter number of the blank region above the subject key code is “zero or more [≧0],” and that the letter number of the blank region below the subject key code is “zero or more [≧0].”

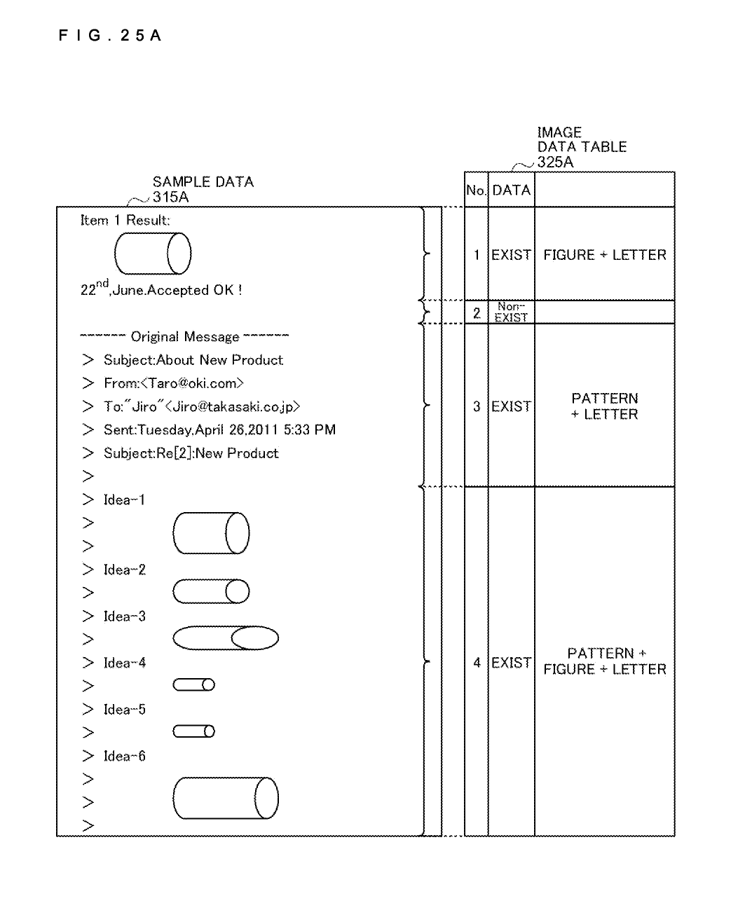

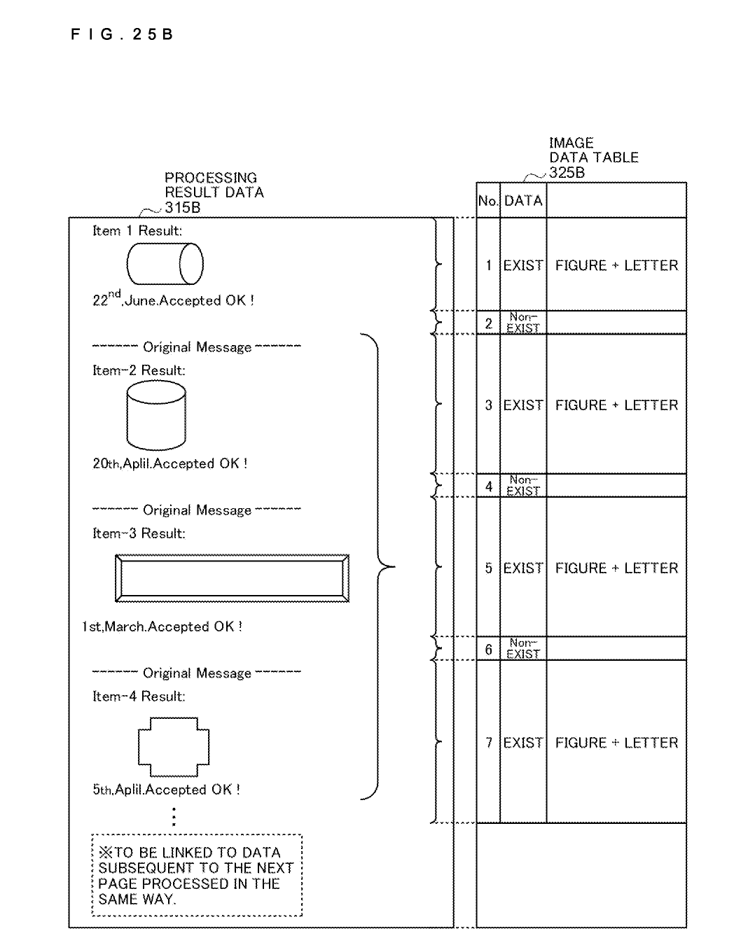

The information processing system 1C can also perform, e.g., the processing shown in FIG. 25A and FIG. 25B as an example. FIG. 25A and FIG. 25B are diagrams, respectively showing a processing example of the information processing system according to the third embodiment. FIG. 25A shows preprocessing printing sample data 315A and an image data table 325A showing its structural contents. FIG. 25B shows post-processing printing sample data 315B and an image data table 325B showing its structural contents.

In the example shown in FIG. 25A, the post-processing processing result data 315B have the data below “No. 3” of the image data table 325A shown in FIG. 25A deleted in comparison with the pre-processing printing sample data 315A. That is, the information processing system 1C deletes the portion of the past text all at once.

In the example shown in FIG. 25A, the pre-processing printing sample data 315A have a structure that the past text contains data of some ideas and that new text contains data relating to decisive matters in association with the ideas. It is to be noted that the printing sample data 315A herein also have substantially the same structure at the next page or later.

Herein, the past text may be not necessary if the user expects printing of the data relating to decisive matters only. In such a case, the information processing system 1C can delete the past text all at once.

Detection of the past text can be realized by setting the extension modifiers in a way that the subject key code is set to the sign “>,” that the letter number of the blank region above the subject key code is “zero or more [≧0],” and that the letter number of the blank region below the subject key code is “zero or more [≧0].”

The information processing system 1C, in substantially the same way as the information processing system 1 according to the first embodiment, can make the image data of the subsequent page or below link to the image data of the previous page where image data exist for plural pages. The information processing system 1C can condense the image data of plural pages into single page data by linking the image data of the subsequent page or below to an empty region of the previous page. In the example shown in FIG. 25B, the processing result data 315B have the structure with the linkage of the image data of the subsequent page or below subjecting to substantially the same deletion processing to an empty region of the previous page. The information processing system 1C thus formed can obtain a large resource saving effect over the entire printing job data in substantially the same way as the information processing system 1 according to the first embodiment.

In the third embodiment, the user sets arbitrary signs as the subject key codes used for detection of the editing subject data as the redundant data in the information processing system 1C. The user, at that time, can delete the blank region data contained in the original data files as the editing subject data serving as the redundant data as a matter of course, if setting data such as “space,” “tab,” “return code” as the structural element of the blank region data shown in FIG. 5 to be the subject key codes.

In the third embodiment, in the information processing system 1C, the information processing terminal 10C displays the setting screen 603 (see, FIG. 28) of the subject key code of the printer driver at the display device 13a, and the user sets the subject key codes and the extension modifiers on the setting screen 603. In the information processing system 1C, however, the image forming apparatus 20C may display a menu screen at the display manipulation unit 23, and the user may set the subject key codes and the extension modifiers on the menu screen.

FIG. 29 is a diagram showing an example of a display manipulation unit used in the third embodiment. FIG. 29 shows a structure of an operator panel 701 serving as the display manipulation unit 23. In the example shown in FIG. 29, the operator panel 701 has a structure formed with an up scroll key 711, a down scroll key 712, an enter key 713, a return key 714, and a ten key 715.

The user manipulates the up scroll key 711, the down scroll key 712, and the ten key 715 in looking at the menu screen to select signs, spaces, tabs, alphabetic and numeric letters, and enters the letters by pushing down the entry key 713. A cursor displayed on the display device moves right. The user can move back the cursor by one letter by pushing down the return key 714. The user enters the letters to be set by pushing down the enter key 713 if setting up to the limited letter number. The user can set the subject key codes and the extension modifiers in this manner.

The operator panel 701 can use a variety of signs, spaces, tabs, alphabetic and numeric letters, in a case where the subject key codes and the extension modifiers are set. The operator panel 701 can also use logical operation formulae including equal signs and signs of inequality. The operator panel 701 can also set the letter number of the blank region as the extension modifier. The letter number can be set in association with either or both of the portions above or below the subject key code.

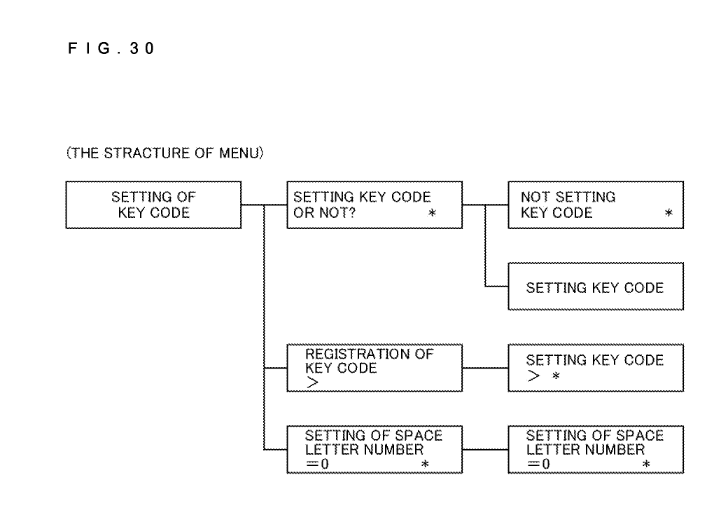

The image forming apparatus 20C can easily set the subject key codes and the extension modifiers if such an operator panel 701 is provided. The operator panel 701 can do complicated settings by scrolling the items on the menu screen or moving the layers of the screens, even where having a structure formed with several switches only. FIG. 30 is a diagram showing an example of a layered structure of the screens used in the third embodiment.

In the information processing system 1C thus formed, the particular letter data (including pattern data of the particular string) judged as an unnecessary portion by the user are set as one or more of the subject key codes in advance; the editing subject data are identified based on the subject key codes and the extension modifiers by setting the extension modifiers extending the definitions of the editing subject data in association with the respective subject key codes; the editing subject data serving as the redundant data matching various conditions can be detected. Therefore, the information processing system 1C can remove the redundant data unnecessary for the users with efficiency better than that of the information processing system 1 according to the first embodiment.

As described above, according to the information processing system 1C according to the third embodiment, the redundant data for users can be removed in substantially the same way as the information processing system 1 according to the first embodiment. The information processing system 1C therefore can save the resources of printing medium (paper) more than the conventional information processing system and can save not only the printing medium but also the resources such as developer (toner) and electric power more than the conventional information processing system. According to the information processing system 1C, images easily viewed by users can be printed. Moreover, according to the information processing system 1C, the setting range of the condition data used for detecting the editing subject data as the redundant data can be changed in detail because the extension modifiers for extending the definitions of the editing subject data in association with the respective subject key codes can be set.

This invention is not limited to the embodiments described above but can be changed or modified in various ways as far as not deviated from the scope and spirit of the invention.

For example, the invention is not limited to printers, but also is applicable to image forming apparatuses such as facsimile machines, photocopiers, and MPF in which the users can print the data or look up the data when needed. The “MPF” is an abbreviation of multifunction printer/peripheral, and is an apparatus having a printer added with functions of facsimile, scanner, photocopy, etc.

The information processing terminal 10B according to the second embodiment, for example, can have a structure including the subject designation unit 11Ce and the subject judgment unit 11Cf of the information processing system 10C according to the third embodiment, in lieu of the subject designation unit 11e and the subject judgment unit 11f. Similarly, the image forming apparatus 20B according to the second embodiment can have a structure including the subject designation unit 21Ce and the subject judgment unit 21Cf of the image forming apparatus 20C according to the third embodiment, in lieu of the subject designation unit 21e and the subject judgment unit 21f. In those cases, the information processing terminal 10B and the image forming apparatus 20B according to the second embodiment can set plural subject key codes and can set the extension modifiers extending the definitions of the editing subject data in association with the respective subject key codes.

The information processing terminal 10C according to the third embodiment, for example, can have a structure including the deletion executing unit 11ga and the reduction executing unit 11Bga of the information processing terminal 10B according to the second embodiment. Similarly, the image forming apparatus 20C according to the third embodiment can have a structure including the deletion executing unit 21ga and the reduction executing unit 21Bga of the image forming apparatus 20B according to the second embodiment. In those cases, the user can choose either of the deletion processing and the reduction processing as the removing processing of the redundant data.

What is claimed is:

1. An information processing apparatus comprising:
a designating unit for designating a particular letter or string;
a judging unit for judging as to whether line data forming text data include the particular letter or string designated by the designating unit; and
an editing unit for editing the line data judged by the judging unit as including the particular letter or string.

2. The information processing apparatus according to claim 1, wherein the editing unit edit the line data to delete a portion of the line data below the particular letter or string.

3. The information processing apparatus according to claim 1, wherein the editing unit deletes the line data as editing processing in a case where the line data are in combination with blank data.

4. The information processing apparatus according to claim 1, wherein the particular letter or string is inputted from an inputting unit by a user whereas the blank data are prepared at a memory unit in advance.

5. The information processing apparatus according to claim 1, wherein the editing unit deletes the line data of an incident line or lines as editing processing.

6. The information processing apparatus according to claim 1, wherein the editing unit deletes a return code of each line in a region that the incident lines continue as editing processing in a case where the incident lines including the particular letter or string continue among plural lines forming the text data.

7. The information processing apparatus according to claim 1, wherein the editing unit deletes blank data and a return code of each line and leaves only the particular letter or string of each line in a region that the incident lines continue as editing processing in a case where the line data are pattern data in which the particular letter or string and the blank data are combined.

8. The information processing apparatus according to claim 6, wherein the editing unit counts up a number of the particular letter or string and converts the particular letter or string into pattern data in which the particular letter or string and counted number data are combined.

9. The information processing apparatus according to claim 1, wherein the designating unit receives particular letters or strings in a plural number.

10. The information processing apparatus according to claim 1, wherein the designating unit receives a pattern made of a logical operation formula using a sign or signs of equality or inequality designated by a user in association with the particular letter or string, and wherein the judging unit identifies the data subject to the editing processing based on the particular letter or string and the pattern received with the designating unit.

11. The information processing apparatus according to claim 1, wherein the editing unit condenses plural page data into single page data by linking each page data with data of a previous page and a subsequent page among the text data subject to the editing processing.

12. The information processing apparatus according to claim 1, wherein the editing unit performs the same editing processing for spread sheet data as that for the text data.

13. The information processing apparatus according to claim 1, further comprising an outputting unit for outputting post editing processing data processed at the editing unit to an exterior.

14. An image forming apparatus formed from the information processing apparatus according to claim 1, further comprising a printing unit for forming, on a printing medium, post editing processing data edited at the editing unit.

15. An information processing method comprising the steps of:
designating a particular letter or string;
judging as to whether line data forming text data include the particular letter or string based on the particular letter or string;
performing editing processing to the line data judged as including the particular letter or string; and
outputting text data subject to the editing processing to an exterior.

16. An information processing system comprising:
a designating unit for designating a particular letter or string;
a judging unit for judging as to whether line data forming text data include the particular letter or string designated with the designating unit; and
an editing unit for performing editing processing to the line data judged as including the particular letter or string by the judging unit.
